(19) United States
(12) Patent Application Publication
(10) Pub. No.: US 2005/0078848 A1
(43) Pub. Date: Apr. 14, 2005

(54) Power amplifier and method for split voice coil transducer or speaker

(75) Inventor: Stefan R. Hlibowicki, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Audio Products International Corp., Scarborough (CA)

(21) Appl. No.: 10/681,339

(22) Filed: Oct. 9, 2003

(51) Int. Cl. H04R 1/00; H04R 9/06; H04R 11/02

(52) U.S. Cl. 381/401; 381/400; 381/402

(57) ABSTRACT

The present invention relates to a method and power amplifier for providing an audio current comprising a first audio current and a second audio current to a split voice coil speaker having a first coil and a second coil located in a magnetic field. The first coil and the second coil are wired such that current can be provided to one coil without providing current to the other coil. The first audio current is provided to a first branch connected to the first coil. The second audio current is provided to a second branch connected to the second coil. The first audio current differs from the second audio current. The first audio current in the first coil and the second audio current in the second coil are oriented such that both the first audio current and the second audio current constructively contribute to a force provided to the voice coil.

### FIELD OF THE INVENTION

This invention relates generally to audio power amplifiers. More particularly, it relates to an audio power amplifier for a split voice coil transducer or speaker.

### BACKGROUND OF THE INVENTION

As the cone of an operating speaker moves in both directions, the force generated by the speaker voice coil has to have an alternating character. This is achieved in conventional speakers by connecting an amplifier that supplies alternative or bi-directional current to the voice coil of a single coil speaker.

Power amplifiers are built using power devices such as vacuum tubes or transistors. These devices control the amount of current that flows from the power supply to the amplifier output based on the applied input signal. The vacuum tube or transistor modulates current intensity but cannot change current polarity. One reason for this is that the vacuum tube or transistor is connected to the power supply, which has constant polarity. The second reason comes from the fact that a vacuum tube or bipolar transistor can conduct current in one direction only. This is why two such power devices are required to build an amplifier. One power device is connected between a positive power supply and the amplifier output while the second power device is connected between a negative power supply and the amplifier output. The amplifier output acts as a subtracting node where signals from both devices meet.

The control of the power devices is simplified if they are connected in the same way to the circuit ground, particularly if their cathodes, emitters or sources are connected to the circuit ground. In this case, only one power supply, positive or negative, can be used, and an alternating current cannot be obtained (except when using a power audio transformer, which is costly and does not work at very low frequencies or DC). If this configuration is used to build a power amplifier without a power audio transformer, then some other mechanism must be provided to provide an alternating force in the speaker.

The split coil speaker provides such a mechanism for providing an alternating force in the speaker. Both coils together, work as subtracting device. That is, instead of subtracting currents one subtract forces with the same result for the speaker operation. In such speakers, each coil is placed in a magnetic field created by a magnet and is energized with an electric current. Each conducting coil then experiences a force created by the magnetic field of the magnet and the coil current. This force is used to drive a speaker cone to produce sound.

U.S. Pat. No. 2,959,640 (Schultz) and U.S. Pat. No. 4,130,725 (Nagel) disclose split coil transducers combined with class B amplifiers. Class B, push-pull or other amplifiers alternate the current between coils by delivering a current to one coil at a time. That is, while the current is supplied to one coil, no current is supplied to the other coil. However, for reasons that are discussed below, this reduces efficiency and increases heat dissipation in the transducer or speaker. It is possible to increase the density of the magnetic flux in the transducer to reduce heat dissipation; however, this is expensive as it requires a much larger magnet.

It is very important for bifilar speaker systems to include power amplifiers capable of delivering high power at high efficiency, as reduced efficiency may impair cooling or increase cost due to the need to include large heat sinks. Accordingly, a high efficiency power amplifier for a split voice coil transducer is desirable.

### SUMMARY OF THE INVENTION

In accordance with a first aspect of the present invention, there is provided a switching power amplifier for connection to a split voice coil of a speaker. The split voice coil has a first coil and a second coil located in a magnetic field, the first coil and the second coil being wired such that current can be provided to one coil without providing current to the other coil. The power amplifier comprises: a first branch for providing a first audio current to the first coil; a second branch for providing a second audio current to the second coil, wherein the first audio current differs from the second audio current; and a transformer for transferring energy between the first branch and the second branch such that both the first audio current and the second audio current constructively contribute to a force provided to the voice coil.

In accordance with a second aspect of the present invention, there is provided a method of providing an audio current comprising a first audio current and a second audio current to a split voice coil speaker having a first coil and a second coil located in a magnetic field. The first coil and the second coil are wired such that current can be provided to one coil without providing current to the other coil. The method comprises providing the first audio current to a first branch connected to the first coil; providing the second audio current to a second branch connected to the second coil, wherein the first audio current differs from the second audio current; orienting the first audio current in the first coil and the second audio current in the second coil such that both the first audio current and the second audio current constructively contribute to a force provided to the voice coil.

In accordance with a third aspect of the present invention, there is provided a speaker comprising a split voice coil having a first coil and a second coil located in a magnetic field, the first coil and the second coil being wired such that current can be provided to one coil without providing current to the other coil, and a power amplifier. The power amplifier comprises a first branch for providing a first audio current to the first coil; a second branch for providing a second audio current to the second coil, wherein the first audio current differs from the second audio current; and a transformer for transferring energy between the first branch and the second branch such that both the first audio current and the second audio current constructively contribute to a force provided to the voice coil.

### BRIEF DESCRIPTION OF THE DRAWINGS

A detailed description of the preferred embodiments is provided herein below with reference to the following drawings in which:

FIG. 1, in a schematic view, illustrates a speaker with a split voice coil showing the polarity of applied voltages and currents;

FIG. 2 is a graph illustrating ratios of total power dissipated in the split voice coil of FIG. 1 under different conditions;

FIG. 3a is a schematic view of a full bridge class D power amplifier in accordance with the prior art;

FIG. 3b is a schematic view of a half bridge class D power amplifier in accordance with the prior art;

FIG. 4, in a simplified schematic diagram, illustrates a power amplifier in accordance with the present invention;

FIG. 5, in a graph, plots the power transistor currents in the amplifier of FIG. 4 as a function of time;

FIG. 6, in a graph, plots the normalized currents provided to the voice coils against a modulation coefficient a;

FIG. 7, in a graph, plots relative increase in the power dissipated as a function of the modulation coefficient a;

FIG. 8, in a functional schematic view, illustrates a power amplifier in accordance with a further embodiment of the invention;

FIG. 9, in a graph, plots the time each power transistor is on as a function of the modulation coefficient a;

FIG. 10, in a graph, plots the switching frequency between the power transistors as a function of the modulation coefficient a for two different values of bias currents expressed by their normalized values a_{b};

FIG. 11, in a graph, plots the relationship between duty cycle and the modulation coefficient a;

FIG. 12, in a graph, illustrates the polarities and relationships between the power transistor threshold currents and the modulation coefficient a;

FIG. 13, in a graph, plots power transistor drain voltages as a function of time;

FIG. 14, in a graph, plots a ratio of maximum drain voltage to supply voltage as a function of the modulation coefficient a;

FIG. 15, in a graph, plots examples of waveforms of speaker voice coil currents assuming a sinusoidal input signal;

FIG. 16, in a graph, illustrates the phenomena of cross-over distortions;

FIG. 17, in a graph, illustrates a method of compensating for cross-over distortions;

FIG. 18, in a functional schematic view, illustrates a power amplifier employing a circuit for cross-over distortion compensation in accordance with a further embodiment of the invention;

FIG. 19, in a detailed schematic view, illustrates the power amplifier of FIG. 18;

FIG. 20, in a graph, plots the power transistor drain voltages and shows voltage spikes caused by parasitic inductances of a switching transformer;

FIG. 21, in a graph, illustrates an example of control waveforms in the power amplifier of FIGS. 22 and 25;

FIG. 22, in a functional schematic view, illustrates a power amplifier class “A” in accordance with an embodiment of the invention;

FIG. 23, in a graph, illustrates the time on for each power transistor in the power amplifier of FIGS. 22 and 25 as a function of the modulation coefficient a;

FIG. 24, in a graph, plots an example of switching frequency in the power amplifier of FIGS. 22 and 25 as a function of the modulation coefficient a; and,

FIG. 25, in a detailed schematic view, illustrates the power amplifier of class “A” of FIG. 22.

### DETAILED DESCRIPTION OF THE PREFERRED EMBODIMENTS OF THE INVENTION

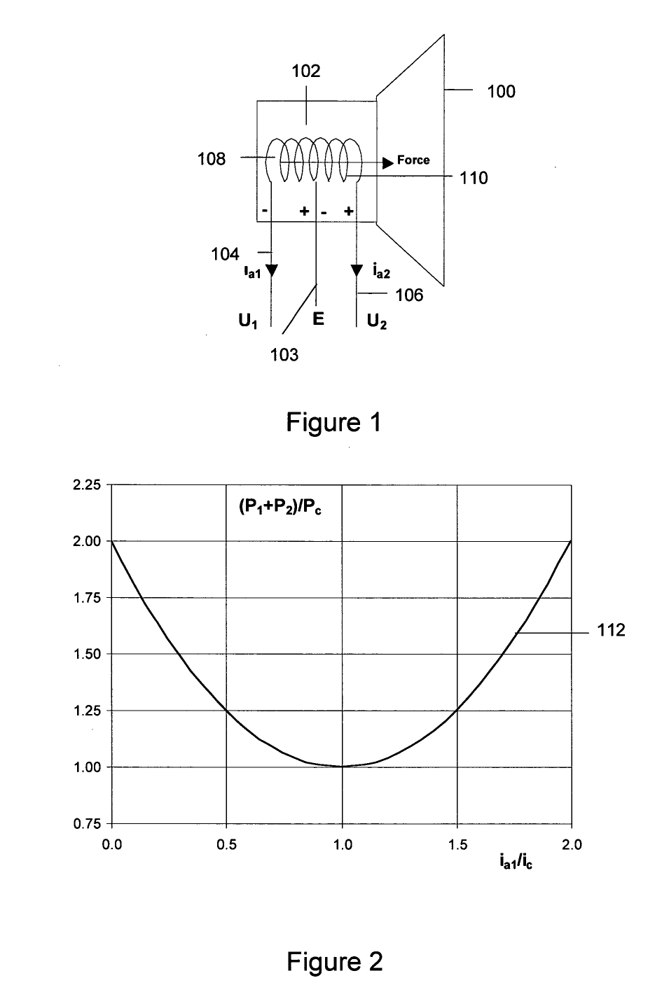

Referring to FIG. 1, there is illustrated in a schematic view, a speaker 100 with a dual split voice coil 102 in accordance with the prior art. Voltages U₁ and U₂ are applied to the extreme terminals 104, 106 of voice coil 102, while voltage E is applied to common terminal 103. The resulting currents iₐ₁ and iₐ₂ flow through the voice coil 102, which sits in a magnetic flux created by a magnet (not shown) within speaker 100. The current flowing through the voice coil 102 causes a force to act on the voice coil 102 according to the equation F=Bli where F is the force, B is the magnetic flux in which the wire is placed, l is the length of the wire and i is the current running through the wire (this equation assumes that the wire is perpendicular to the magnetic flux). The means by which the force F can be used to create sound are well known in the art.

The split voice coil 102 is in fact composed of two coils 108, 110. These coils may be split, dual, overlay or bifilar voice coils. The forces created by coils 108 and 110 respectively are given as:
F₁=B₁·l₁·iₐ₁ (1)
F₂=B₂·l₂·(−iₐ₂) (2)
where B₁ and B₂ are the densities of magnetic flux within which each of the coils 108 and 110 is placed respectively, l₁ and l₂ are the lengths of the wires or conductors of each of the coils, and iₐ₁ and iₐ₂ are the currents through each of the coils. The second current is indicated as negative given that, as shown in FIG. 1, it is opposite in direction to the first current.

Typically, magnetic flux is not uniformly distributed along the voice coil. One way of dealing with this is to have B₁ and B₂ represent the average densities of magnetic flux along the length of the coil. Another way of dealing with this is to assume non-uniform values of magnetic flux density B₁ and B₂ and define each of l₁ and l₂ to be the effective length of its respective coil.

Symmetrical coils can be provided by two identical voice coils being positioned side-by-side, one coil being wound on top of another coil (overlay) or both coils made simultaneously using bifilar coils. Bifilar coils assure almost identical coils, but methods in which one coil is overlaid on top of another give very similar results.

For the case of two coils that are symmetrically positioned with respect to a magnetic field created by the magnet in the voice coil gap, the following relationships hold:

$$\begin{matrix}{B}_{1} = {B}_{2} = B & ( 3 ) \\ {l}_{1} = {l}_{2} = \frac{l}{2} & ( 4 )\end{matrix}$$

Thus, the total force resulting from both coils is

$$F = {F}_{1} + {F}_{2} = B \cdot l \cdot \frac{{i}_{a 1} - {i}_{a 2}}{2} \qquad ( 5 )$$

The voice coils must deliver the force required to move the speaker components. This force can be generated by one coil at a time, or by both simultaneously. That is, the force generated by the coils can result from an equal distribution of current between the two coils, by an uneven distribution of current between the two coils, or, in the extreme, by current being provided to only one coil at a time. The two extreme cases are considered below. In the first case, current is only provided to the first coil, such that iₐ₂=0. In the second case, the coils are equally active as equal amounts of current are supplied to each: iₐ₁=−iₐ₂=i_{c}, where i_{c} is a hypothetical current through both currents simultaneously that provides the same force as the sum of the forces generated by the actual component currents iₐ₁ and iₐ₂. In both cases, the force F must be the same to get the same sound from the speaker. Thus, in the first case iₐ₁=2·i_{c}.

Current flowing through the coils' resistances dissipates heat. Each coil has a resistance equal to R/2. Thus, the power P₁ dissipated in the first coil can be expressed as follows:

$${P}_{1} = \frac{R}{2} \cdot {( {i}_{a 1} )}^{2} + 0 = \frac{R}{2} \cdot {( 2 \cdot {i}_{c} )}^{2} = 2 \cdot R \cdot {i}_{c}^{2} \qquad ( 6 )$$

Where equal currents are provided to each coil, the total power P_{c} dissipated can be calculated as follows:

$${P}_{c} = \frac{R}{2} \cdot {( {i}_{c} )}^{2} + \frac{R}{2} \cdot {( {i}_{c} )}^{2} = R \cdot {i}_{c}^{2} \qquad ( 7 )$$

Combining these two equation yields
P₁=2P_{c} (8)

From this equation, it is apparent that when a current is provided to only one coil, as opposed to being divided equally between both coils, the power dissipated is doubled. However, to complete this analysis, it is necessary to consider cases in which iₐ₁≠0 and iₐ₂≠0 Specifically, in these cases,

$${P}_{1} + {P}_{2} = \frac{R}{2} \cdot ( {i}_{a 1}^{2} + {i}_{a 2}^{2} ) \qquad ( 9 )$$

As current iₐ₂ flows in the opposite direction to current iₐ₁,

$${i}_{c} = \frac{{i}_{a 1} - {i}_{a 2}}{2} \qquad ( 10 )$$

current i_{c} dissipates power P_{c}
P_{c}=R·i_{c}² (11)
Combining equations (9) and (11) gives

$$\frac{{P}_{1} + {P}_{2}}{{P}_{c}} = \frac{{i}_{a 1}^{2} + {i}_{a 2}^{2}}{2 \cdot {i}_{c}^{2}} \qquad ( 12 )$$

Combining equations (10) and (12) yields

$$\frac{{P}_{1} + {P}_{2}}{{P}_{c}} = 2 - 2 \cdot ( \frac{{i}_{a 1}}{{i}_{c}} ) + {( \frac{{i}_{a 1}}{{i}_{c}} )}^{2} \qquad ( 13 )$$

FIG. 2, in a graph, illustrates a normalized plot 112 of the ratio of the total power dissipated in both coils to the power dissipated by current i_{c} as a function of the ratio of the current through coil 110 to the current flowing through both coils, according to equation (13). The plot 112 indicates that the point of a minimum power dissipation is, as expected, at

$$\frac{{i}_{a 1}}{{i}_{c}} = 1.$$

For example,

$$if \frac{{i}_{a 1}}{{i}_{c}} = 0.5 or if \frac{{i}_{a 1}}{{i}_{c}} = 1.5 ,$$

in which case iₐ₁/iₐ₂=⅓ or iₐ₁/iₐ₂=3 respectively, then one will need 25% more power for the same force. Thus, in general, the more uniform the current distribution between the coils is, the higher the efficiency. High efficiency is particularly important in high power systems, where even a small decrease in efficiency translates to a large amount of dissipated heat.

U.S. Pat. No. 2,959,640 (Schultz) and U.S. Pat. No. 4,130,725 (Nagel) disclose the use of class B amplifiers for split coil transducers. Class B, push pull or other amplifiers alternate the current between coils at audio frequencies by delivering the current to half of the coils at a time with the other half being left inactive. According to the foregoing analysis, this leads to a 50% reduction in the maximum possible efficiency, and to the above-described problem of increased heat dissipation.

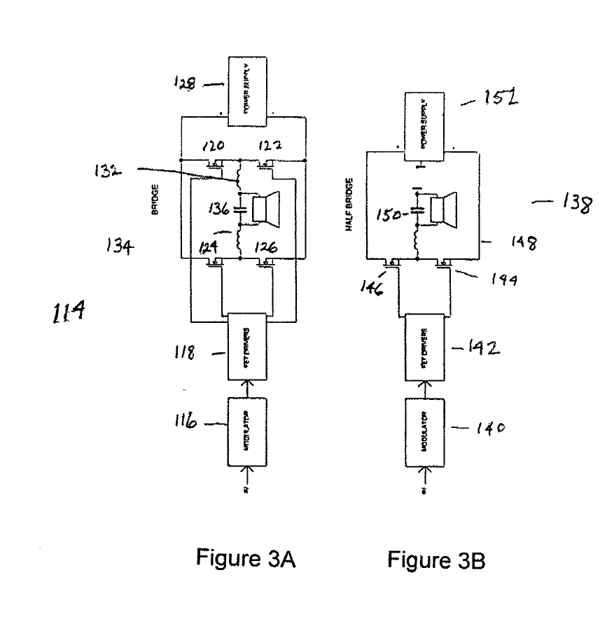

Referring to FIG. 3a, there is illustrated in a schematic view, a full bridge class D amplifier 114 according to the prior art. The amplifier 114 includes a modulator 116 to which an input signal is applied. Based on the input signal provided, the modulator 116 provides signals to the field effect transistor (FET) driver 118, which, in turn, drives the transistors 120, 122, 124, 126. The transistors 120, 122, 124, 126 are powered by the power supply 128 and drive the speaker 130 through a filter comprising inductors 132 and 134, as well as a capacitor 136.

Referring to FIG. 3b, there is illustrated in a schematic view a half bridge class D amplifier 138 in accordance with the prior art. The amplifier 138 includes a modulator 140 to which an input signal is provided. Based on the input signal provided, the modulator 140 provides appropriate signals to the FET driver 142, which, in turn, drives the transistors 144, 146. However, unlike the full bridge configuration of FIG. 3, only two transistors 144, 146 are required. The filter of the amplifier 138 includes an inductor 148 and a capacitor 150. Unlike the amplifier 114 of FIG. 3a, amplifier 138 requires a dual power supply 151.

The amplifiers 114 and 138 of FIGS. 3a and 3b respectively suffer from the disadvantage of requiring high side FET drivers. These circuits are complicated and difficult to construct, especially for high power applications with highly reactive loads.

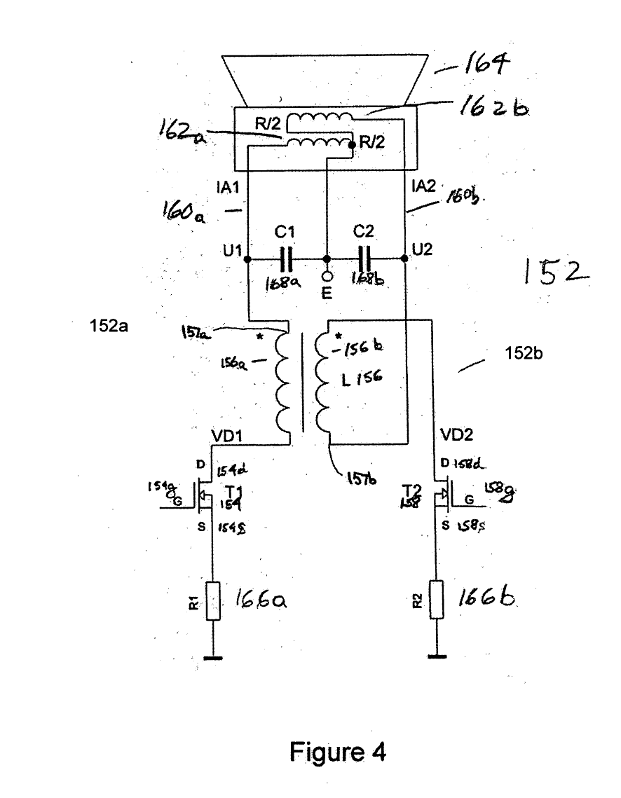

Referring to FIG. 4, there is illustrated in a schematic view, an amplifier 152 in accordance with an aspect of the present invention. As shown, the amplifier 152 includes a power supply voltage E, a branch 152a and a branch 152b. The branch 152a includes a transistor 154, having a source 154s, gate 154g, and drain 154d and a half winding 156a of a transformer winding 156 (which may be a high frequency transformer or an impulse transformer). Similarly, the branch 152b includes a transistor 158b having a source 158s, gate 158g and drain 158d, and a half winding 156b of the transformer 156. Branch 152a is connected to terminal 160a of speaker coil 162a, while branch 152b is connected to speaker terminal 160b of speaker coil 162b. The terminals of the transformer 156 are connected such that the two currents provided by the transistors 154 and 158 flowing in the same direction in each branch would enter the transformer through terminals 157a and 157b respectively, which are of opposite polarity.

The transformer 156 has a 1:1 turn ratio and an inductance L. As shown, it is connected in series between the transistor drains 154d and 158d and the terminals 160a and 160b of the split voice coil speaker 164. The transistor drains 154d and 158d are connected to transformer terminals of different polarities. Transistors 154 and 158 are switched on and off alternatively upon reaching the threshold currents i₁ and i₂ respectively. These currents are sensed using resistors 166a and 166b of branches 152a and 152b respectively, which are connected in series with their associated transistor source terminals 154s and 158s respectively.

Amplifier 152 also includes filtering capacitors 168a and 168b, which are sufficiently large such that voltages U₁ and U₂ at the speaker terminals at 160a and 160b remain relatively constant during switching intervals T₁ and T₂.

The power transistors 154 and 158 alternately allow current to flow through each of the branches according to the input signal. This, in turn, energizes each of the coils 162a and 162b to thereby produce sound. The transformer 156 stores the energy produced by the conducting branch and transfers it to the other branch when the transistor of the conducting branch switches off and that of the non-conducting branch switches on. When a voltage source is connected across the terminals of an inductor, the inductor's current increases linearly according to the following equation:

$$U = L \cdot \frac{ⅆ i}{ⅆ T} \qquad ( 14 )$$

where U is the applied voltage, di is the increment of current, and dT is the increment of time.

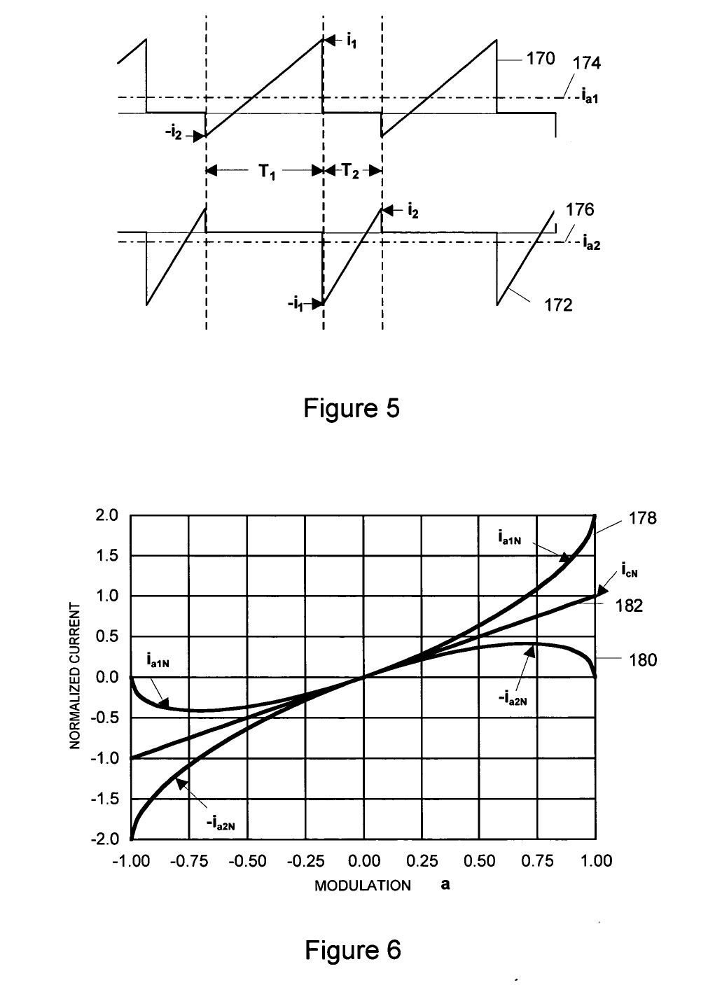

Referring to FIG. 5, the waveforms of current through each transistor 154 and 158 are illustrated. When the transistor 154 is turned off, current from the inductor 156 starts to flow through transistor 158. The absolute value of the current within the inductor does not change during this transition. Instead, only its direction changes due to the way the transformer 156 is connected to the circuit. The same happens during the next transition when transistor 158 turns off and transistor 154 turns on. Thus, as shown in FIG. 5, the initial current for transistor 154 is −i₂ and the initial current for transistor 158 is −i₁. Referring back to equation (14), the following equations for the voltages U₁ and U₂ at speaker terminals 160a and 160b respectively can be determined:

$$\begin{matrix}{U}_{1} = L \cdot \frac{{i}_{1} - ( - {i}_{2} )}{{T}_{1}} = L \cdot \frac{{i}_{1} + {i}_{2}}{{T}_{1}} & ( 15 ) \\ {U}_{2} = L \cdot \frac{{i}_{2} - ( - {i}_{1} )}{{T}_{2}} = L \cdot \frac{{i}_{2} + {i}_{1}}{{T}_{2}} & ( 16 )\end{matrix}$$

From these equations, we derive that
U₁·T₁=U₂·T₂ (17)

The drain currents of the switching transistors 154 and 158 have high frequency components and DC components. The high frequency components are buffered by capacitors 168a and 168b such that only the DC or average values iₐ₁ and iₐ₂ of the drain currents reach the speaker coils 168a and 168b. These average values are given by the following equations:

$$\begin{matrix}{i}_{a1} = \frac{{i}_{1} - {i}_{2}}{2} \cdot \frac{{T}_{1}}{{T}_{1} + {T}_{2}} & ( 18 ) \\ {i}_{a2} = \frac{{i}_{1} - {i}_{2}}{2} \cdot \frac{{T}_{2}}{{T}_{1} + {T}_{2}} & ( 19 )\end{matrix}$$

T₁+T₂ is the period of the currents i₁ and i₂. These equations were derived by assuming triangular waveforms of currents as shown in FIG. 5. Specifically, referring to FIG. 5, waveform 170 is the current through the source of power transistor 154, while waveform 172 is the current through the source of power transistor 158. Waveforms 170 and 172 would typically be at frequencies between 100 and 200 kilohertz. Lower frequencies could be used, but this will require larger inductors. Further, the frequency should not be so low that these waveforms are audible. Higher frequencies may also be used, depending on technologies available. Similarly, stippled line 174 designates the average current value iₐ₁ actually supplied to the coil 168a, and stippled line 176 designates the average current iₐ₂ actually supplied to the speaker coil 168b. Typically, waveforms 174 and 176 would have frequencies in the audible range of 20 hertz to 20 kilohertz, although for some speaker systems, waveforms 174 and 176 may have frequencies below 20 hertz—the pressure waves generated by these waveforms would not be heard, but could be felt.

As shown in FIG. 5, during period T₁ transistor 154 conducts current while transistor 158 does not. As shown in FIG. 5, this situation is reversed during time period T₂ during which transistor 158 conducts while transistor 154 does not. As shown in FIG. 5, the frequency of current waveforms 170 and 172 is much higher than the frequency of current waveforms 174 and 176. Due to this fact, the currents iₐ₁ and iₐ₂ which represent audio signals appear to be constant in FIG. 5; however, if the X axis of FIG. 5 were extended over a suitably long period of time, these audio signals would be seen to vary in accordance with the audio content of the signal. These audio signals are also constant and concurrently provided over the period of waveforms 170 and 172, despite the fluctuations in current waveforms 170 and 172, due to the capacitors 168a and 168b that filter the high frequency component of the signal out before it reaches the coils 162a and 162b. The currents iₐ₁ and iₐ₂ are also oriented in the coils 162a and 162b respectively such that both currents iₐ₁ and iₐ₂ constructively contribute to the force provided to the voice coil 162. That is, given the configuration of the coils 162a and 162b in FIG. 4, the currents iₐ₁ and iₐ₂ have opposite polarities as shown in FIG. 5. This is also shown by equation (18) and (19).

In the discussion that follows, i₀ is defined to be the difference between i₁ and i₂. That is
i₁−i₂=iᵢ (20)

Substituting this equation into equations (18) and (19), yields

$$\begin{matrix}{i}_{a1} = \frac{{i}_{0}}{2} \cdot \frac{{T}_{1}}{{T}_{1} + {T}_{2}} & ( 21 ) \\ {i}_{a2} = - \frac{{i}_{0}}{2} \cdot \frac{{T}_{2}}{{T}_{1} + {T}_{2}} & ( 22 )\end{matrix}$$

Combining equations (21) and (22) yields the relation

$${i}_{a1} - {i}_{a2} = \frac{{i}_{0}}{2} \qquad ( 23 )$$

The flows of these average currents through voice coils 168a and 168b, each of which has resistance R/2, create the following voltage drops respectively:

$$\begin{matrix}E - {U}_{1} = \frac{R}{2} \cdot {i}_{a1} & ( 24 ) \\ E - {U}_{2} = \frac{R}{2} \cdot {i}_{a2} & ( 25 )\end{matrix}$$

where E is the power supply voltage. Solving for U₁ and U₂ using the above equations (21), (22), (23), (24) and (25), yields

$$\begin{matrix}{U}_{1} = E - \frac{R \cdot {i}_{0}}{4} \cdot \frac{{T}_{1}}{{T}_{1} + {T}_{2}} & ( 26 ) \\ {U}_{2} = E + \frac{R \cdot {i}_{0}}{4} \cdot \frac{{T}_{2}}{{T}_{1} + {T}_{2}} & ( 27 )\end{matrix}$$

The above, equations (17), (26) and (27) can be solved. This solution can be simplified by introducing a modulation coefficient a, where

$$\frac{R \cdot {i}_{0}}{4 \cdot E} = a \qquad ( 28 )$$

Substituting the modulation coefficient a into equations yields

$$\begin{matrix}{U}_{1} = \frac{E}{2} \cdot ( 1 - a + \sqrt{1 - {a}^{2}} ) & ( 29 ) \\ {U}_{2} = \frac{E}{2} \cdot ( 1 + a + \sqrt{1 - {a}^{2}} ) & ( 30 )\end{matrix}$$

Clearly, a must conform to the following condition
−1≦a≦1 (31)

The modulation coefficient a expresses the degree of achieving maximum possible values during amplifier operations. From equations (24), (25), (29) and (30), the following relations can be derived

$$\begin{matrix}{i}_{a1} = \frac{E}{R} \cdot ( 1 + a - \sqrt{1 - {a}^{2}} ) & ( 32 ) \\ {i}_{a2} = \frac{E}{R} \cdot ( 1 - a - \sqrt{1 - {a}^{2}} ) & ( 33 )\end{matrix}$$

The amplifier of FIG. 4 will work with a wide range of loads and supply voltages. Accordingly, the foregoing equations can be normalized as follows:
i_{a1N}=1+a−\sqrt{1−a²} (34)
i_{a2N}=1−a−\sqrt{1−a²} (35)

Referring to FIG. 6, these normalized currents are plotted in a graph in which normalized current is plotted against the modulation coefficient a. That is, lines 178 and 180 indicate the currents through coils 162a and 162b respectively. Line 182 designates the current that would flow through both coils in order to generate the same force.

Recall from equations (3) and (10) above that
F=F₁+F₂=B·l·i_{c} (36)

From equations (10), (32) and (33) it follows that

$${i}_{c} = \frac{E}{R} \cdot a \qquad ( 37 )$$

The term E/R is common to equations (32), (33) and (37). From the foregoing, it can be deduced that for the normalized value i_{cN} of current i_{c},
i_{cN}=a (38)
This relation is represented by straight line 182 in FIG. 6.

Current i_{c} in its normalized version i_{cN} is a hypothetical current through both coils simultaneously that provide the same force as the sum of the forces generated by the actual component currents iₐ₁ and iₐ₂.

From equations (37), (36), (28) and (20), the following equation can be derived:

$$F = B \cdot l \cdot \frac{{i}_{1} - {i}_{2}}{4} \qquad ( 39 )$$

This equation shows that the force F generated by the voice coil assembly is a linear function of a or i₁-i₂. That is, despite the fact that the individual voice coil currents are non-linear functions of the input signal as shown in FIG. 6, their sum is perfectly linear as shown by equation (39). If the difference between the threshold currents i₁ and i₂ is controlled to correspond to the input audio signal, the system response will be clean and without distortion.

Ideally, switching power amplifiers do not experience any energy losses. This is also the case of the amplifier according to the present invention. If that is the case, the total power Pₜ dissipated in both coils can be represented by the equation
Pₜ=P₁+P₂=E·(iₐ₁+iₐ₂) (40)
Combining this equation with equations (32) and (33) yields

$${P}_{t} = \frac{{E}^{2}}{R} \cdot 2 \cdot ( 1 - \sqrt{1 - {a}^{2}} ) \qquad ( 41 )$$

The power P_{c} dissipated by the current i_{c} is

$${P}_{c} = \frac{{E}^{2}}{R} \cdot {a}^{2} \qquad ( 42 )$$

The ratio

$$\frac{{P}_{t}}{{P}_{c}}$$

is then given by the following equation:

$$\frac{{P}_{t}}{{P}_{c}} = 2 \cdot \frac{1 - \sqrt{1 - {a}^{2}}}{{a}^{2}} \qquad ( 43 )$$

A similar result could be derived from equations (13), (32) and (37) or (13), (34) and (38).

Recall that equation (13) is

$$\frac{{P}_{1} + {P}_{2}}{{P}_{c}} = 2 - 2 \cdot ( \frac{{i}_{a 1}}{{i}_{c}} ) + {( \frac{{i}_{a 1}}{{i}_{c}} )}^{2}$$

This equation can be used for any signal provided the substitute currents are expressed by their root means square (RMS) values and all have the same shape. It can also be used in the case of the present amplifier provided that all the currents are DC currents. Accordingly, equation (43) is valid for a DC signal only.

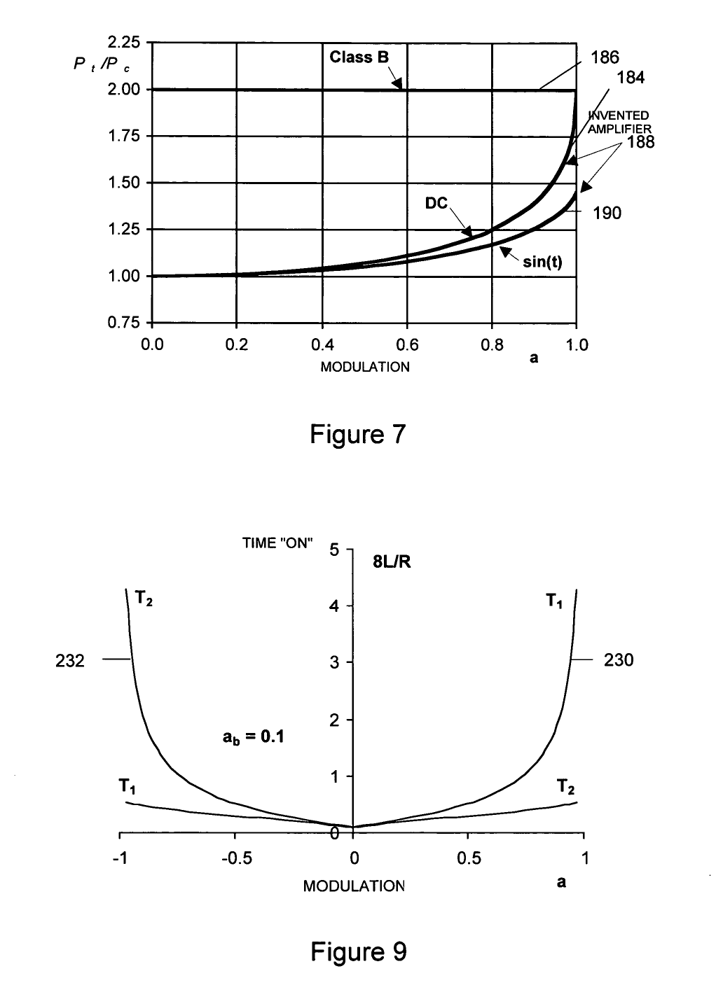

Referring to FIG. 7, the ratio

$$\frac{{P}_{t}}{{P}_{c}}$$

is plotted against the modulation coefficient a according to equation (43). This is line 184 in the graph. The power dissipation is shown relative to the power dissipated when both coils are conducting evenly. Thus, as can be seen from curve 186 of graph 188, which represents power dissipation by class B amplifiers, class B amplifiers always dissipate twice the power due to the fact that only one coil is conducting at a time. Curve 184, determined by equation (43), indicates the power dissipated when the input signal is a DC signal. Curve 190 indicates the power dissipated when the signal is sinusoidal.

Equation (43) is not applicable in the case of a sinusoidal signal. Accordingly, the appropriate powers must be calculated using equations (41) and (42). Modulation coefficient a has to be substituted by a(t)=a·sin(t). Substituting this equation yields

$$\begin{matrix}{P}_{t} = \frac{{E}^{2}}{R} \cdot \frac{2}{π} \cdot {\int }_{0}^{π} ( 1 - \sqrt{1 - {( a \cdot sin ( t ) )}^{2}} ) ⅆ t & ( 44 ) \\ {P}_{c} = \frac{{E}^{2}}{R} \cdot \frac{1}{π} \cdot {\int }_{0}^{π} {( a \cdot sin ( t ) )}^{2} ⅆ t = \frac{{E}^{2}}{R} \cdot \frac{{a}^{2}}{2} & ( 45 )\end{matrix}$$

Combining these equations yields

$$\frac{{P}_{t}}{{P}_{c}} = 2 \cdot \frac{{\int }_{0}^{π} ( 1 - \sqrt{1 - {( a \cdot sin ( t ) )}^{2}} ) ⅆ t}{{\int }_{0}^{π} {( a \cdot sin ( t ) )}^{2} ⅆ t} = \frac{4}{π \cdot {a}^{2}} \cdot {\int }_{0}^{π} ( 1 - \sqrt{1 - {( a \cdot sin ( t ) )}^{2}} ) ⅆ t \qquad ( 46 )$$

Plotting the curve yielded by equation (46) provides line 190 of FIG. 7.

The advantages of the amplifier of FIG. 4 are readily apparent from FIG. 7. If the modulation for the sinusoidal signal reaches 0.8, then the additional power dissipation is only 17% of the power dissipation that would result if both coils were working uniformly—i.e. if equal currents were being supplied to both coils. By contrast, with class B and other amplifiers in which coils are powered alternately, the additional power dissipation will always be 100% of what the powered dissipation would be if both coils were working uniformly, regardless of the value of the modulation coefficient. However, FIG. 7 compares the losses of power in the speaker only. In addition to these losses, class B amplifiers will have their own losses and limited efficiency, unlike switching amplifiers, which enjoy efficiencies close to 100%.

As is apparent from FIG. 5, the amplifier 152 operates by switching the power transistors alternatively ON and OFF whenever their currents reach certain values. As a result, the amplifier 152 is self-oscillating and the switching frequency is related to the values of the amplifier components.

Recall that modulation coefficient a determined by the following equations:

$$a = \frac{R \cdot {i}_{0}}{4 \cdot E} = \frac{R \cdot ( {i}_{1} - {i}_{2} )}{4 \cdot E} \qquad ( 47 )$$

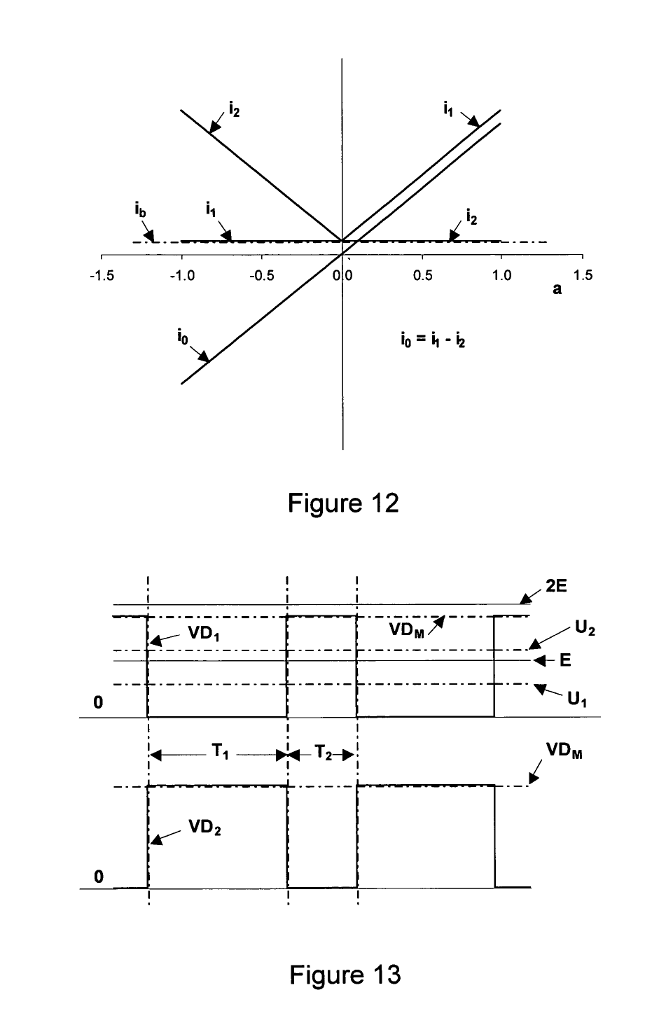

The value of the modulation coefficient a can be positive or negative and varies according to the input signal. However, the threshold currents i₁ and i₂ must always be positive. Accordingly, additional circuitry must be added to the amplifier 152 for this amplifier to operate properly. For the purpose of this analysis, it is assumed that while one of the currents i₁ or i₂ varies, the other remains constant as shown in FIG. 12. The initial or biasing current i_{b} and its normalized value a_{b} are then related by equation (48) similar to equation (28)

$${a}_{b} = \frac{R \cdot {i}_{b}}{4 \cdot E} \qquad ( 48 )$$

Algebraic transformation of equations (15), (16), (20), (29), (30), (28) and (48), and substitution of one of the currents by current i_{b} lead to equations (49) and (50) for switching times T₁ and T₂:

$$\begin{matrix}{T}_{1} = \frac{8 \cdot L}{R} \cdot \frac{a + 2 \cdot {a}_{b}}{1 - a + \sqrt{1 - {a}^{2}}} & ( 49 ) \\ {T}_{2} = \frac{8 \cdot L}{R} \cdot \frac{a + 2 \cdot {a}_{b}}{1 + a + \sqrt{1 - {a}^{2}}} & ( 50 )\end{matrix}$$

From equations (49) and (50), the switching frequency fₛ and duty cycle D can be determined:

$$\begin{matrix}{f}_{s} = \frac{1}{{T}_{1} + {T}_{2}} = \frac{R \cdot \sqrt{1 - {a}^{2}}}{8 \cdot L \cdot ( \vert a \vert + 2 \cdot {a}_{b} )} & ( 51 ) \\ D = \frac{{T}_{1}}{{T}_{1} + {T}_{2}} = \frac{\sqrt{1 + a}}{\sqrt{1 + a + \sqrt{1 - a}}} & ( 52 )\end{matrix}$$

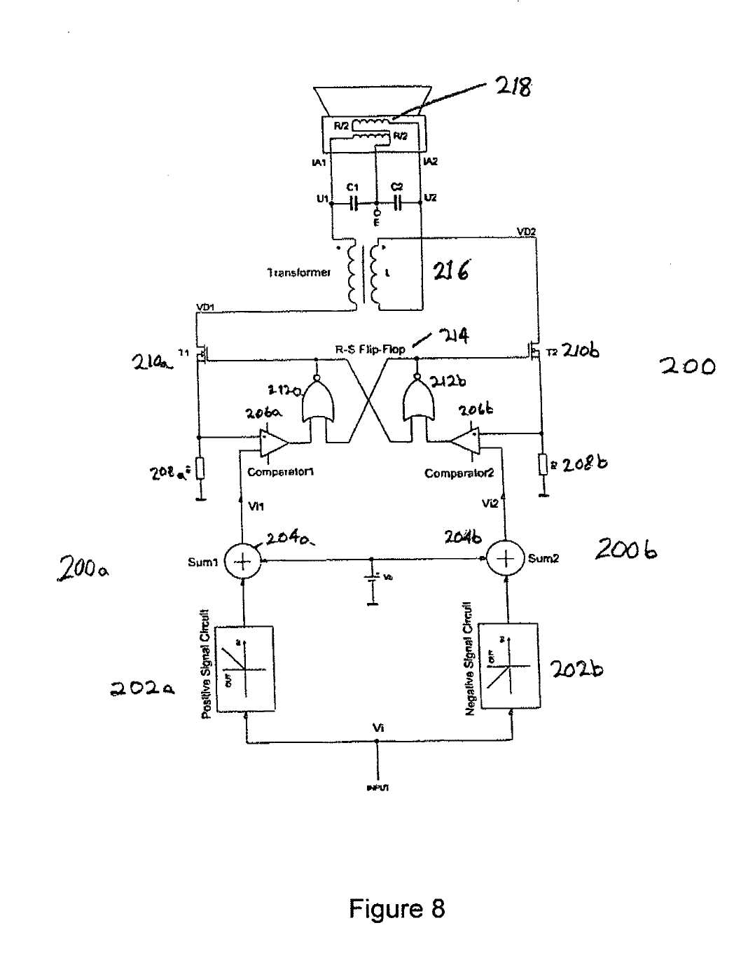

Referring to FIG. 8, there is illustrated in a functional schematic view, an amplifier 200 in accordance with a preferred embodiment of the invention. As illustrated, the amplifier 200 consists of two main branches 200a and 200b, each of which processes either the positive or negative portion of the input signal. An input signal V₁ is fed to the inputs of two very similar circuits, called the Positive Signal Circuit (PSC) 202a and Negative Signal Circuit (NSC) 202b. The output voltage of the PSC 202a equals its input voltage if the input voltage is positive and equals zero if the input voltage is negative. The output voltage of the NSC 202b equals zero if the input voltage is positive and equals the inverted input voltage when the input voltage is negative. The output of PSC 202a is connected to summing circuit 204a, while the output of NSC 202b is connected to summing circuit 204b. The summing circuits 204a and 204b add constant and positive voltage V_{b} to the output voltages of the PSC 202a and the NSC 202b, thereby generating voltages Vᵢ₁ and Vᵢ₂ respectively. The relationship between voltages Vᵢ₁ and Vᵢ₂, and input voltage Vᵢ, is described by equations (54) and (55):

$$\begin{matrix}{V}_{i 1} = \frac{1}{2} ( \vert {V}_{i} \vert + V i ) + {V}_{b} & ( 53 ) \\ {V}_{i 2} = \frac{1}{2} ( \vert {V}_{i} \vert - V i ) + {V}_{b} & ( 54 )\end{matrix}$$

Voltages Vᵢ₁ and Vᵢ₂ are always positive and their minimal values equals V_{b}. A graph plotting equations (53) and (54) would look quite similar to the graph of FIG. 12.

Referring back to FIG. 8, each branch of the amplifier circuit 200 includes a voltage comparator 206a and 206b. Comparator 206a compares voltages Vᵢ₁ and the voltage across a sensing resistor 208a, while comparator 206b compares voltages Vᵢ₂ and the voltage across sensing resistor 208b. The operation of voltage comparators are known by those of skill in the art. The current sensing resistors 208a and 208b convert transistor currents to voltages. If the drain current of transistor 210a is higher than voltage Vᵢ₁ divided by the value of resistor 208a, then the output of comparator 206a is the binary output one. Contrariwise, if the current obtained by dividing the voltage Vᵢ₁ by the value of the resistance of resistor 208a is higher than the drain current of transistor 210a, then the comparator outputs zero. Similarly, comparator 206b outputs one when the drain current of transistor 210b is higher than voltage Vᵢ₂ divided by the resistance of resistor 208b, and outputs a zero when the drain current of transistor 210b is lower than voltage Vᵢ₂ divided by the resistance of resistor 208b.

Each branch 200a and 200b of the amplifier 200 also includes a NOR gate 212a and 212b respectively. The NOR gates 212a and 212b are cross-coupled so as to produce an R-S flip-flop 214. The R-S flip-flop has two complementary outputs. Say that the output connected to the gate of transistor 210a represents logical one and the output to transistor 210b represents logical zero. The drain current of transistor 210a then increases linearly and at some point of time reaches value i₁=Vᵢ₁/R₁. This occurrence is illustrated in the vertical shifts of FIG. 5. At this point of time, the output signal of comparator 206a changes from zero to one. This changes the state of the R-S flip-flop 214 and turns the transistor 210a OFF and transistor 210b ON. The state of R-S flip-flop 214 remains constant after this until the rising current of transistor 210b crosses the value i₂ determined by Vᵢ₂ and the resistance of resistor 208b, and then the cycle repeats—i.e. the output of comparator 206b changes from zero to one, thereby changing the state of the R-S flip-flop and turning the transistor 210a ON and the transistor 210b OFF. The entire circuit 200 oscillates with the frequency given by equation (51) above, and peak currents i₁ and i₂ vary with the input signal (FIG. 12).

The current sensing resistors 208a and 208b should have identical resistances. If this is the case, then

$$\begin{matrix}{i}_{1} = \frac{{V}_{i 1}}{{R}_{1}} & ( 55 ) \\ {i}_{2} = \frac{{V}_{i 2}}{{R}_{1}} & ( 56 )\end{matrix}$$

From equations (39) and (53) to (56), the following equality can be derived:

$$F = B \cdot l \cdot \frac{{V}_{i}}{4 \cdot {R}_{1}} \qquad ( 57 )$$

This equation shows that the force generated by the speaker motor assembly is a linear function of the input voltage Vᵢ. The current sensing circuitry controls the power transistors 210a and 210b so that the amplifier 200 works as a current amplifier as indicated by equation (57). FIG. 9 illustrates in a graph the switching times for power transistors 210a and 210b as a function of the modulation coefficient a. The vertical axis shows time ON and is expressed as a multiple of 8L/R, where L is inductance of the transformer 216 and R is the total resistance of the coil 218. Curve 230 represents the time ON for transistor 210a, while curve 232 illustrates the time ON for power transistor 210b.

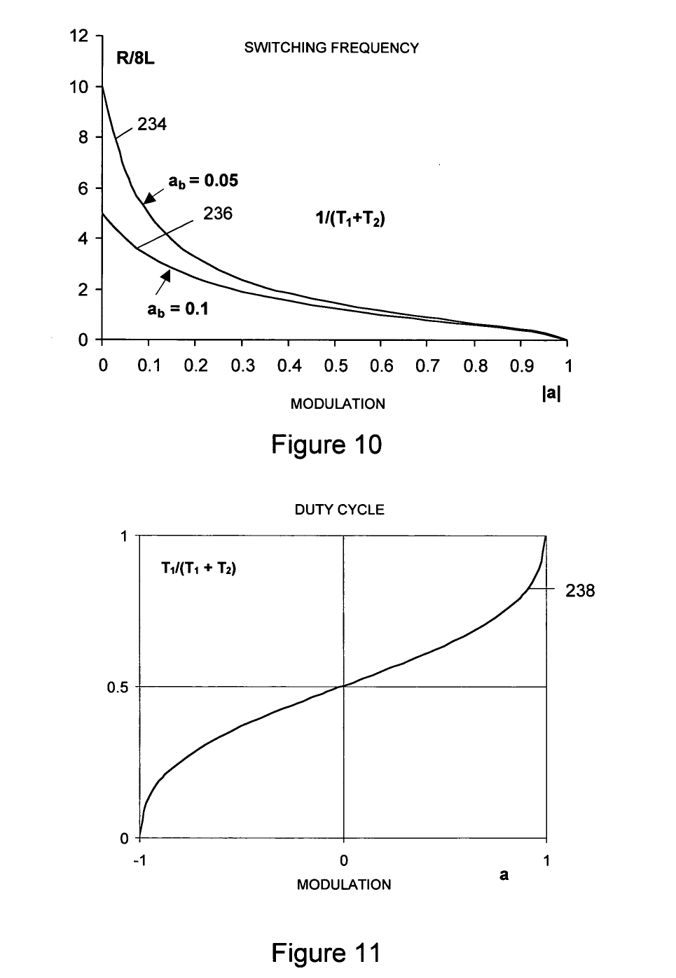

FIG. 10, in a graph, illustrates the switching frequency as a function of the absolute value of modulation coefficient a. The vertical axis is expressed as multiples of R/8L, similar to FIG. 9. Curve 234 represents the switching frequency for a biasing current having a normalized value of 0.05. Curve 236 represents the switching frequency for a biasing current having a normalized value of 0.1. From curves 234 and 236 of FIG. 10 and from curves 230 and 232 of FIG. 9, it is apparent that both times T₁ and T₂ increase, and the switching frequencies decrease, when the signal value increases. The biasing current i_{b} has the highest influence on times and frequency when the input signal is small. The duty cycle is independent of i_{b}.

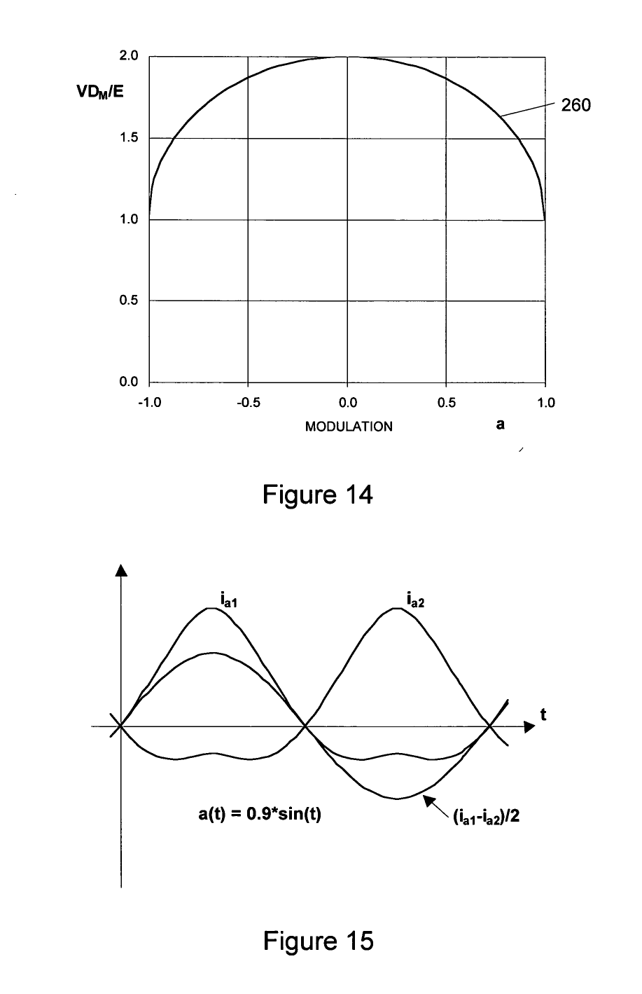

When one of the transistors is ON, the other one is OFF and its drain voltage equals VD_{M}. With no input signal, modulation coefficient a equals zero, and VD_{M} is twice as high as the power supply voltage E. The exact value of VD_{M} as function of the modulation coefficient a is given by the following equation:
VD_{M}=U₁+U₂=E·(1+\sqrt{1−a}) (58)
The function described by this equation is plotted as curve 260 in FIG. 14. VD_{M} should not be higher than the maximum rated voltage of the chosen transistors.

The present analysis was conducted, and the equations were derived on the basis of the assumption that the speaker impedance does not vary with frequency. In actuality, this is not the case. However, equation (39) is valid notwithstanding this. As a consequence, the force generated by the motor structure of the speaker depends only on the difference between currents i₁ and i₂, and, as shown by equation (57), depends on input voltage Vᵢ alone. An amplifier in accordance with an embodiment of the present invention consequently behaves like a normal current mode power amplifier in responding to variations in speaker impedance.

Equations (53), (54), (55) and (56) define the relationship between threshold currents i₁ and i₂, and input signal V₁ represented by modulation coefficient a. This relationship is also illustrated by the graph of FIG. 12. Specifically, FIG. 12 illustrates the function of PSC 202a, NSC 202b, summing circuit 204a, and summing circuit 204b of FIG. 8, and a bias voltage V_{b}. Bias voltage V_{b} is responsible for generating the biasing current i_{b}. From FIG. 12, it is apparent that current i₀ varies linearly with modulation a and input signal.

Referring to FIG. 13, there is illustrated in a graph the relationship between transistor drain voltages VD₁ and VD₂, voltages at the speaker terminals U₁ and U₂, maximum drain voltage VDₘ and supply voltage E as a function of time. From FIG. 13 it is apparent that while voltage U₁ is smaller than supply voltage E, voltage U₂ is larger than supply voltage E; however, all voltages are smaller than 2 E.

Referring to FIG. 15, there is illustrated in a graph examples of waveforms of speaker currents iₐ₁ and iₐ₂ through each coil, assuming sinusoidal audio input signals and modulation coefficient 0.9. FIG. 15 shows that despite individual coil currents being distorted, the difference between the individual coil currents, which is responsible for generating the force, is sinusoidal and free from distortion. This graph is analogous the graph of FIG. 6; the one being for a instantaneous values of an audio input signal while the other is for a sinusoidal audio input signal as a function of time.

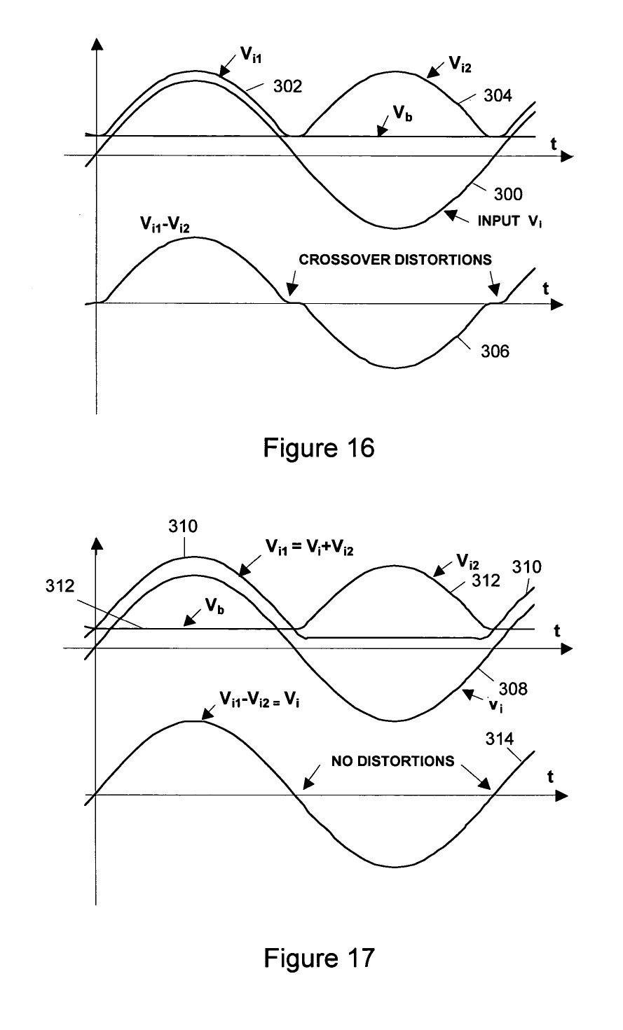

Referring back to FIG. 8, the operation of the PSC 202a and the NSC 202b resemble the operation of a halfway rectifier. That is, the output signal represents only the positive or negative half cycles of an applied sinusoidal input signal. The amplifier 200 uses two such circuits. It is particularly important that the characteristics of the PSC 202a and NSC 202b be closely matched and appropriately shaped. If not, then the amplified signal will have distortions. Consider the example of a simple diode and resistor circuit. The diode needs a certain bias voltage to conduct current. This means that only voltages higher than the bias voltage will appear at the output. This is a typical mechanism for generating so called crossover distortions as illustrated in FIG. 16.

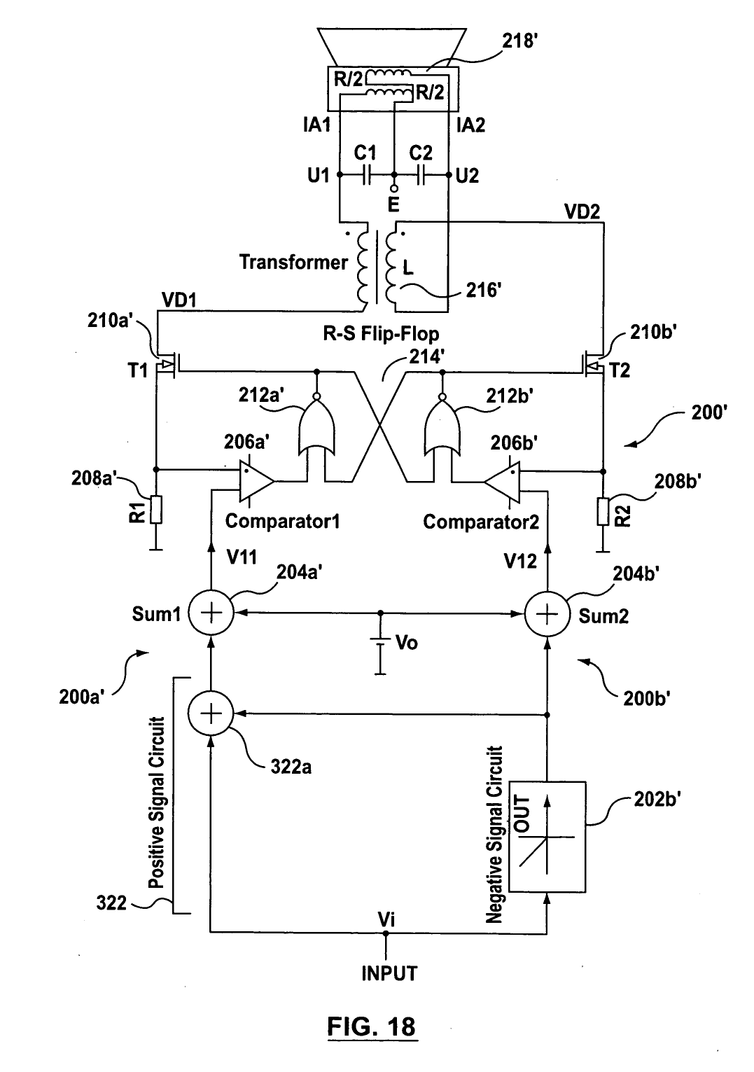

Referring to FIG. 16, there is illustrated a sinusoidal signal represented by curve 300, which is the input signal applied to the amplifier. Curves 302 and 304 are the process input signals applied to the inputs of comparators 206a and 206b respectively. The resulting signal is represented by curve 306. Crossover distortions occur because the diodes used to rectify the waveforms require a minimum voltage to begin conducting. One way around this problem is to use NSC 202b to input into one of the comparators 206a or 206b, while inputting the sum of the original input signal and the output signal of NSC 202b into the other comparator 206b or 206a (FIG. 18).

Referring to FIG. 17, there are illustrated voltage forms, which have been compensated for crossover distortions. In FIG. 17, curve 308 is the input signal applied to the amplifier, and curves 310 and 312 are the process input signals applied to the inputs of comparators 206a and 206b respectively. The resulting signal applied to the amplifier circuit is shown as curve 314. As can be seen, the crossover distortions have been eliminated.

The value of the bias voltage V_{b}, and, as a result, the value of the bias current i_{b} has no affect on the amplifier output signal. If the bias current i_{b} is very small, and there is no input signal, then the amplifier switching occurs at a very high frequency. On the other hand, if i_{b} is large, then the amplifier oscillates at low frequency, but the switching current is large. Thus, the optimal bias current will be a compromise between these two extremes. According to an embodiment of the invention, the bias current is selected to be around 10% of the modulation coefficient a_{b} determined by equation (48). However, this choice of bias current value is not critical.

Referring to FIG. 18, there is illustrated in a functional schematic view, an amplifier 200′ in accordance with a preferred embodiment of the invention. For clarity, the same reference numerals together with an apostrophe are used to designate elements analogous to those described above in connection with FIG. 8. As illustrated, the amplifier 200′ consists of two main branches 200a″ and 200b′, each of which processes either the positive or negative portion of the input signal. An input signal Vᵢ is fed to the inputs of two very similar circuits, called the Positive Signal Circuit (PSC) 322 and Negative Signal Circuit (NSC) 202b′. The output voltage of the NSC 202b′ equals zero if the input voltage is positive and equals the inverted input voltage when the input voltage is negative. The PSC 322 consists of a summing junction 322a the inputs of which are the input signal Vᵢ as well as the output of NSC 202b′. The input/output characteristics of PSC 322 are similar to that of PSC 202a of FIG. 8. When the input signal is negative the output of NSC 202b′ is positive but equal in magnitude. Thus, the output of PSC 322 is 0. When the input signal is positive the output of NSC 202b′ is 0 and the output of PSC 322 is simply the input signal. The output of PSC 302 is connected to summing circuit 204a′, while the output of NSC 202b′ is connected to summing circuit 204b′. The summing circuits 204a′ and 204b′ add constant and positive voltage V_{b} to the output voltages of the PSC 322 and the NSC 202b′, thereby generating voltages Vᵢ₁ and Vᵢ₂ respectively. The relationship between voltages Vᵢ₁ and Vᵢ₂, and input voltage Vᵢ, is described by equations (54) and (55) which were given above and are reproduced below:

$$\begin{matrix}{V}_{i 1} = \frac{1}{2} ( \vert {V}_{i} \vert + V i ) + {V}_{b} & ( 53 ) \\ {V}_{i 2} = \frac{1}{2} ( \vert {V}_{i} \vert - V i ) + {V}_{b} & ( 54 )\end{matrix}$$

As explained previously, voltages Vᵢ₁ and Vᵢ₂ are always positive and their minimal values equal V_{b}. A graph plotting equations (53) and (54) would look quite similar to the graph of FIG. 12.

Referring back to FIG. 18, each branch 200a′ and 200b′ of the amplifier circuit 200′ includes a voltage comparator 206a′ and 206b′ respectively. Comparator 206a′ compares voltages Vᵢ₁ and the voltage across a sensing resistor 208a′, while comparator 206b′ compares voltages Vᵢ₂ and the voltage across sensing resistor 208b′. The operation of voltage comparators are known by those of skill in the art. The current sensing resistors 208a′ and 208b′ convert transistor currents to voltages. If the drain current of transistor 210a′ is higher than voltage Vᵢ₁ divided by the value of resistor 208a′, then the output of comparator 206a′ is the binary output one. Contrariwise, if the current obtained by dividing the voltage Vᵢ₁ by the value of the resistance of resistor 208a′ is higher than the drain current of transistor 210a′, then the comparator outputs zero. Similarly, comparator 206b′ outputs one when the drain current of transistor 210b′ is higher than voltage Vᵢ₂ divided by the resistance of resistor 208b′, and outputs a zero when the drain current of transistor 210b′ is lower than voltage Vᵢ₂ divided by the resistance of resistor 208b′.

Each branch 200a′ and 200b′ of the amplifier 200′ also includes a NOR gate 212a′ and 212b′ respectively. The NOR gates 212a′ and 212b′ are cross-coupled so as to produce an R-S flip-flop 214′. Each NOR gate has two complementary outputs. Say that the output connected to the gate of transistor 210a′ represents logical one and the output to transistor 210b′ represents logical zero. The drain current of transistor 210a′ then increases linearly and at some point of time reaches value i₁=Vᵢ₁/R₁. At this point of time, the output signal of comparator 206a′ changes from zero to one. This changes the state of the R-S flip-flop 214′ and turns the transistor 210a′ OFF and transistor 210b′ ON. The state of R-S flip-flop 214′ remains constant after this until the rising current of transistor 210b′ crosses the value i₂ determined by Vᵢ₂ and the resistance of resistor 208b′, and then the cycle repeats—i.e. the output of comparator 206b′ changes from zero to one, thereby changing the state of the R-S flip-flop and turning the transistor 210a′ ON and the transistor 210b′ OFF. The entire circuit 200′ oscillates with the frequency given by equation (51) above, and peak currents i₁ and i₂ vary with the input signal.

The current sensing resistors 208a′ and 208b′ should have identical resistances. If this is the case, then

$$\begin{matrix}{i}_{1} = \frac{{V}_{i 1}}{{R}_{1}} & ( 55 ) \\ {i}_{2} = \frac{{V}_{i 2}}{{R}_{1}} & ( 56 )\end{matrix}$$

From equations (39) and (53) to (56), the following equality can be derived:

$$F = B \cdot l \cdot \frac{{V}_{i}}{4 \cdot {R}_{1}} \qquad ( 57 )$$

This equation shows that the force generated by the speaker motor assembly is a linear function of the input voltage Vᵢ. The current sensing circuitry controls the power transistors 210a′ and 210b′ so that the amplifier 200′ works as a current amplifier as indicated by equation (57).

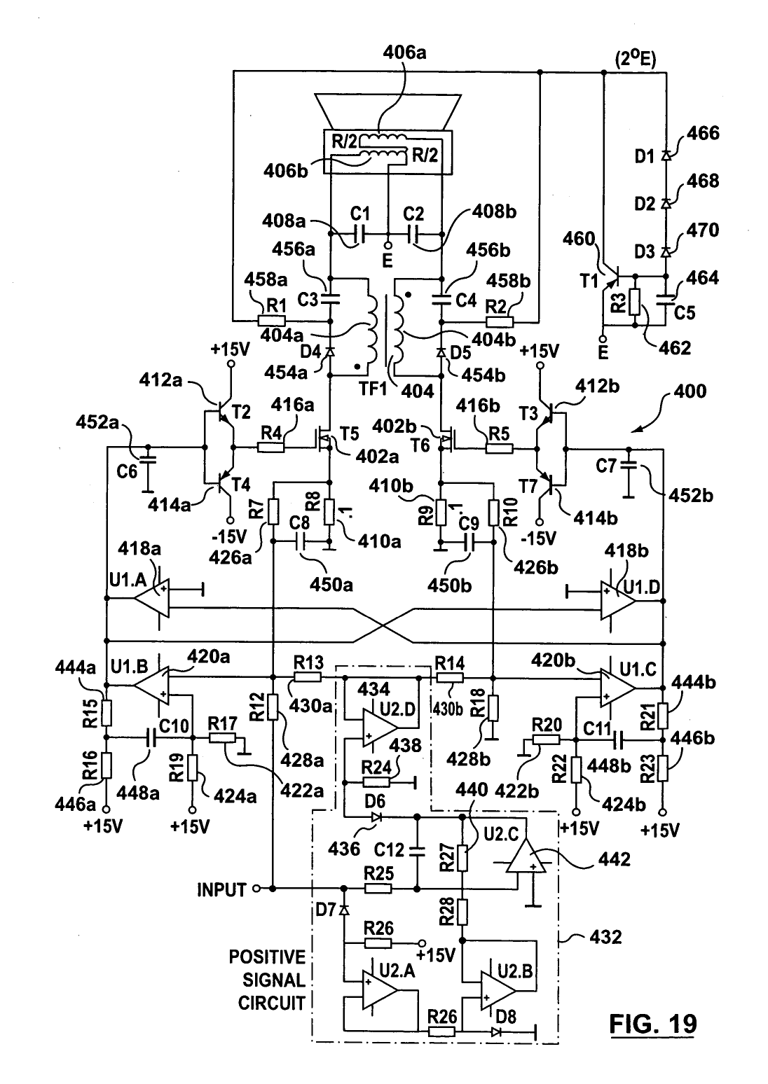

Referring to FIG. 19, there is illustrated in a detailed schematic diagram an amplifier 400 corresponding to the amplifier 200′ of FIG. 18. Transistors 402a and 402b are power-switching transistors, which are connected to transformer 404. That is, the drain of each transistor 402a, 402b is connected to a different winding of transformers 404. In addition, the terminals of transformer 404 to which the drains or transistors 402a, 402b are attached, are of opposite polarity. The other terminals of transformer 404 are connected to the speaker coils, 406a and 406b, as well as to filtering capacitors 408a and 408b.

Resistors 410a and 410b are current sensing resistors connected in series with the source terminals of transistors 402a and 402b. These resistors provide a voltage at the source terminal that is proportional to the current passing through the sources of the transistors 402a and 402b. Small signal transistors 412a and 414a, in typical totem pole configuration, drive the gate of power transistors 402a through resistor 416a. Similarly, small signal transistors 412b and 414b drive the gate of power transistor 402b through resistor 416b. Power transistor 402a and 402b are turned OFF and ON in an alternating fashion when the current through the source of the conducting transistor reaches a threshold value. Thus, there are essentially two states of the circuit, one in which transistor 402a is conducting and the other in which transistor 402b is conducting. As there are periods of time between the switching of transistors in which it is necessary to maintain the current conditions, as well as the signals that affect the current state, a memory storage unit is required to store the current state of the circuit. An R-S flip-flop provides a memory unit for storing the current state of the circuit. The R-S flip-flop comprises voltage comparators 418a, 420a, 418b and 420b, which in practice may be all on the same integrated circuit chip.

Each of the comparators 420a and 420b compare a weighted sum of the current through the source of one of the power transistors 402a and 402b and the input voltage with a reference voltage. The reference voltages are adjusted by two pairs of voltage dividing resistors 422a and 424a, and resistors 422b and 424b. Preferably, the resistance of resistor 422a equals the resistance of resistor 422b, and the resistance of resistor 424a equals the resistance of resistor 424b, thereby causing the two reference voltages to be equal provided the resistors 424a and 424b are connected to the same voltage potential.

The resistors 426a, 428a and 430a, and resistors 426b, 428b and 430b, along with resistors 410a and 410b, are scaling resistors. The relative values of the resistances of these resistors establishes the relationship between the input signal, the threshold currents and the reference voltage. The appropriate resistances for each of the resistors can be determined from simple principles of voltage division. In practice, it is preferable to have the resistance of resistor 410a equal to the resistance of resistor 410b, the resistance of resistor 426a equal to the resistance of resistor 426b, and the resistance of resistor 430a equal to the resistance of resistor 430b, and the resistance of resistor 428a equal to the resistance of resistor 428b, thereby assuring that each comparator uses the same weighted sum of the input voltage, source current and reference voltage.

As described above, the structure of much of the amplifier circuit 400 is symmetrical. That is, one of the halves processes the negative portion of the input signal and the other processes the positive portion. To allow for a similar circuit design for both the negative and positive portions, it is desirable that the relevant portion of the input signals inputted into both branches be either only positive or only negative. This may be accomplished by inverting either the positive or negative portion of the input signal. In the amplifier 400, the Positive Signal Circuit PSC 432 inverts the positive portion of the signal. Within the PSC, there is a buffer stage 434, a half wave rectifier stage including diode 436 and resistor 438, and a signal inverter including resistor 440 and operational amplifier 442. Resistors 444a, 446a, 444b and 446b are pull up resistors that are necessary for the proper operation of the voltage comparators 418a and 418b. Capacitors 448a and 448b provide a feedback loop for the current sensing comparators between the output and non-inverting input. This allows for faster switching times and short dead time zones, which is necessary for the proper functioning of the R-S flip-flop. Capacitors 450a, 450b, 452a and 452b are used to reduce high frequency noise and to improve circuit stability.

Transformer 404 provides for energy storage and transfer. When one of the power transistors 402a or 402b is ON, energy is accumulated within the inductance of the transformer 404 as a result of current flowing through one of the windings of the transformer 404. When the power transistor is turned OFF, and the other transistor is switched on, the energy accumulated in the inductance is released into the second winding as an electrical current.

It is important to achieve effective coupling between both transformer windings 404a and 404b in order to maximize efficiency and limit parasitic inductances that can lower the efficiency of energy transfer and cause voltage spikes in the drain of the switched OFF power transistor. If the voltage spike reaches the transistor breakdown voltage, then this additional energy is discharged through the transistor, dissipating additional heat. This heat energy dissipated should not be higher than the rated avalanche energy of the transistor. However, in high power applications, it is often difficult to limit this energy to below the avalanche energy of the transistor. To compensate for this, the amplifier 400 includes a protective clamping circuit comprising clamping diodes 454a and 454b, capacitors 456a and 456b, resistors 458a and 458b, as well as a discharge circuit, including transistor 460, resistor 462, capacitor 464 and zener diodes 466, 468 and 470. The clamping voltage should be less than the transistor breakdown voltage, and is selected by the zener diodes 466, 468 and 470.

During normal operation, the drain voltages 490 and 492 of transistors 402a and 402b switch between about 0 volts and a voltage close to twice the power supply voltage to E. As a result, diodes 454a and 454b are alternately forward or reverse biased. Forward biased diode 454a charges capacitor 456a so the voltage, at the node where capacitor 466a, diode 454a and resistor 458a are connected, is close to twice the supply voltage. This voltage remains relatively constant because capacitor 466a stores energy during the time when diode 454a is reverse biased. Similarly, forward biased diode 454b charges capacitor 456b so the voltage, at the node where capacitor 456b, diode 454b and resistor 458b are connected, is close to twice the power supply voltage. This voltage remains relatively constant also due to the fact that the capacitor 456b stores energy during the time when diode 454b is reverse biased. Resistors 458a and 458b have very small values necessary to eliminate parasitic oscillations, which occur in any switching circuit. The other terminals of resistors 458a and 458b are connected together and to the collector of transistor 460. Consequently, the value of the voltage at the collector of the transistor 460 remains relatively constant and close to twice the value of the power supply voltage.

Zener diodes 466, 468 and 470 are connected in series and between the collector and the base of transistor 460. They can be replaced with a single diode having a break down voltage equal to the combined voltage of the diodes. However, in many cases lower voltage zener diodes are more readily available.

The combined value of the break down voltages of diodes 466, 468 and 470 is chosen to be slightly above the supply voltage E. On the other hand, the sum of combined values of the break down voltages of diodes 466, 468 and 470 and supply voltage E should be chosen to be below the break down voltage of transistors 402a and 402b. The emitter terminal of transistor 460 is connected to the source of supply voltage E. In consequence, the voltage across diodes 466, 468 and 470 remains below their break down voltages, and there is no current flow through resistor 462. Base emitter voltage of transistor 460 is then 0, and the collector current of this transistor is also zero.

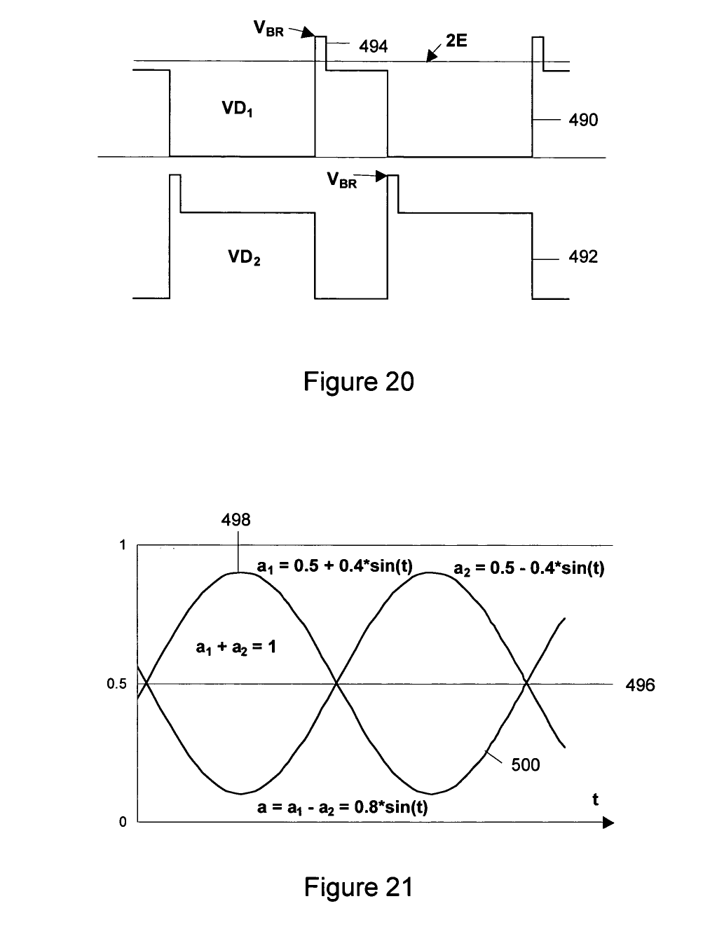

Sudden changes in the drain currents of transistors 402a or 402b caused by switching, together with parasitic inductances of transformer 404, can generate voltage spikes 494, which could damage those transistors. Voltage spikes 494, as shown in FIG. 20, charge capacitors 456a and 456b to higher values and the voltage at the collector of transistor 460 rises. In consequence, the voltage across zener diodes 466, 468 and 470 reach their break down voltage, and current starts to flow through the resistor 462. When the voltage across resistor 462 connected between the emitter and base of transistor 460 reaches about 0.7 volts, the transistor 460 starts to conduct a current. The further increase, even very small, of the voltage at the collector terminal of transistor 460 causes the collector current of this transistor to rise rapidly, never allowing this collector voltage and in consequence the drain voltages of transistors 454a and 454b to rise above twice the value of the supply voltage E. The current stored in the parasitic inductances of transformer 404 is then discharged through forward biased diodes 454a or 454b, and transistor 460 and transistors 402a and 402b are protected.

It is also possible to connect the emitter of transistor 460 to the circuit ground and to double the total break down voltage of the zener diodes. This solution works as well, but dissipates twice as much power in transistor 460 than is dissipated in the above-described example.

FIG. 20 illustrates the voltages 490, 492 at the drains of transistors 402a and 402b. Also shown is the spike 494 reaching transistor break down voltage.

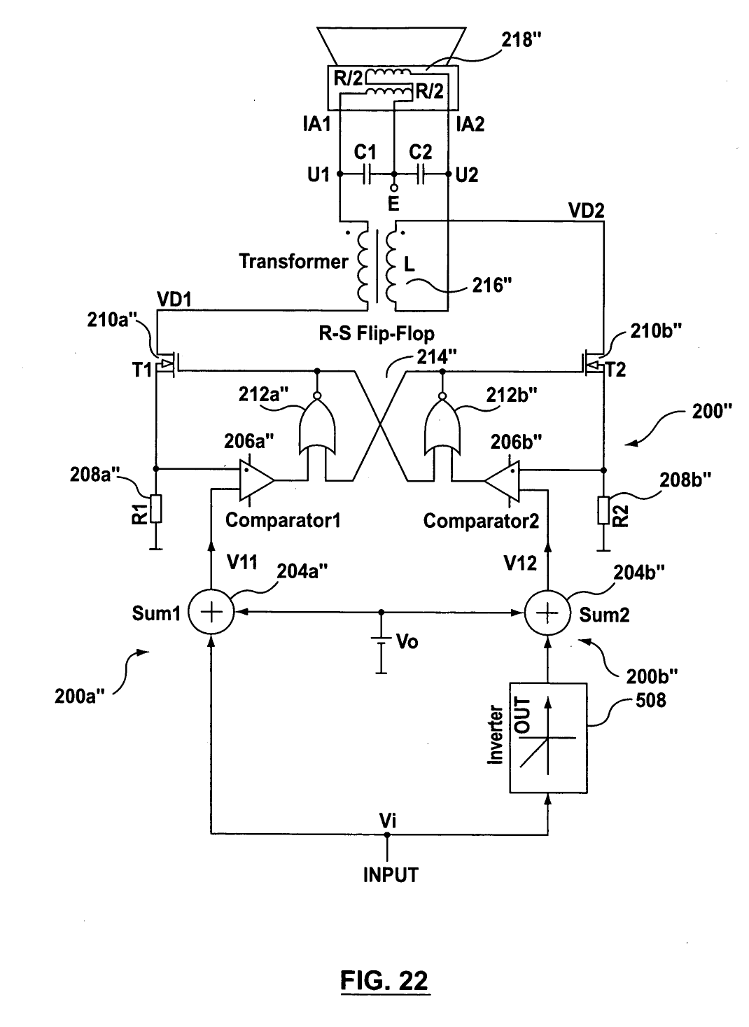

Referring to FIG. 22, there is illustrated in a functional schematic view, an amplifier 200″ in accordance with a preferred embodiment of the invention. For clarity, the same reference numerals together with two apostrophes are used to designate elements analogous to those described above in connection with FIG. 8 and 18. As illustrated, the amplifier 200″ consists of two main branches 200a″ and 200b″, each of which processes either the positive or negative portion of the input signal. An input signal Vᵢ is applied to each branch 200a″ and 200b″. In branch 200a″ the signal is unaltered until reaching the summing junction 204a″ while in the branch 200b″ the signal is inverted by inverter 508 before reaching summing junction 204b″. The summing circuits 204a″ and 204b″ add constant and positive voltage V_{b} to the output voltage to the input signal and the output of the inverter 508, thereby generating voltages Vᵢ₁ and Vᵢ₂ respectively. V_{b} is sufficiently large to ensure that the resulting voltages Vᵢ₁ and Vᵢ₂ are always positive. For a sinusoidal input signal, a graph plotting the voltages Vᵢ₁ and Vᵢ₂ would look quite similar to the graph of FIG. 21.

Referring back to FIG. 22, each branch of the amplifier circuit 200″ includes a voltage comparator 206a″ and 206b″. Comparator 206a″ compares voltages Vᵢ₁ and the voltage across a sensing resistor 208a″, while comparator 206b″ compares voltages Vᵢ₂ and the voltage across sensing resistor 208b″. The operation of voltage comparators are known by those of skill in the art. The current sensing resistors 208a″ and 208b″ convert transistor currents to voltages. If the drain current of transistor 210a″ is higher than voltage Vᵢ₁ divided by the value of resistor 208a″, then the output of comparator 206a″ is the binary output one. Contrariwise, if the current obtained by dividing the voltage Vᵢ₁ by the value of the resistance of resistor 208a″ is higher than the drain current of transistor 210a″, then the comparator outputs zero. Similarly, comparator 206b″ outputs one when the drain current of transistor 210b″ is higher than voltage Vᵢ₂ divided by the resistance of resistor 208b″, and outputs a zero when the drain current of transistor 210b″ is lower than voltage Vᵢ₂ divided by the resistance of resistor 208b″.

FIG. 21 illustrates in a graph the signals 498 and 500 within the amplifier 200″. As shown the signals 498 and 500 are not rectified but are rather inverted with respect to each other with each having a DC signal added to it.

Each branch 200a″ and 200b″ of the amplifier 200″ also includes a NOR gate 212a″ and 212b″ respectively. The NOR gates 212a″ and 212b″ are cross-coupled so as to produce an R-S flip-flop 214″. Each NOR gate has two complementary outputs. Say that the output connected to the gate of transistor 210a″ represents logical one and the output to transistor 210b″ represents logical zero. The drain current of transistor 210a″ then increases linearly and at some point of time reaches value i₁=Vᵢ₁/R₁. At this point of time, the output signal of comparator 206a″ changes from zero to one. This changes the state of the R-S flip-flop 214″ and turns the transistor 210a″ OFF and transistor 210b″ ON. The state of R-S flip-flop 214″ remains constant after this until the rising current of transistor 210b″ crosses the value i₂ determined by Vᵢ₂ and the resistance of resistor 208b″, and then the cycle repeats—i.e. the output of comparator 206b″ changes from zero to one, thereby changing the state of the R-S flip-flop and turning the transistor 210a″ ON and the transistor 210b″ OFF. The entire circuit 200″ oscillates with the frequency given by equation (51) above, and peak currents i₁ and i₂ vary with the input signal. (FIG. 12).

The current sensing resistors 208a″ and 208b″ should have identical resistances. If this is the case, then

$$\begin{matrix}{i}_{1} = \frac{{V}_{i1}}{{R}_{1}} & ( 55 ) \\ {i}_{2} = \frac{{V}_{i2}}{{R}_{1}} & ( 56 )\end{matrix}$$

From equations (39) and (53) to (56), the following equality can be derived:

$$F = B \cdot l \cdot \frac{{V}_{i}}{4 \cdot {R}_{1}} \qquad ( 57 )$$

This equation shows that the force generated by the speaker motor assembly is a linear function of the input voltage Vᵢ. The current sensing circuitry controls the power transistors 210a″ and 210b″ so that the amplifier 200″ works as a current amplifier as indicated by equation (57).

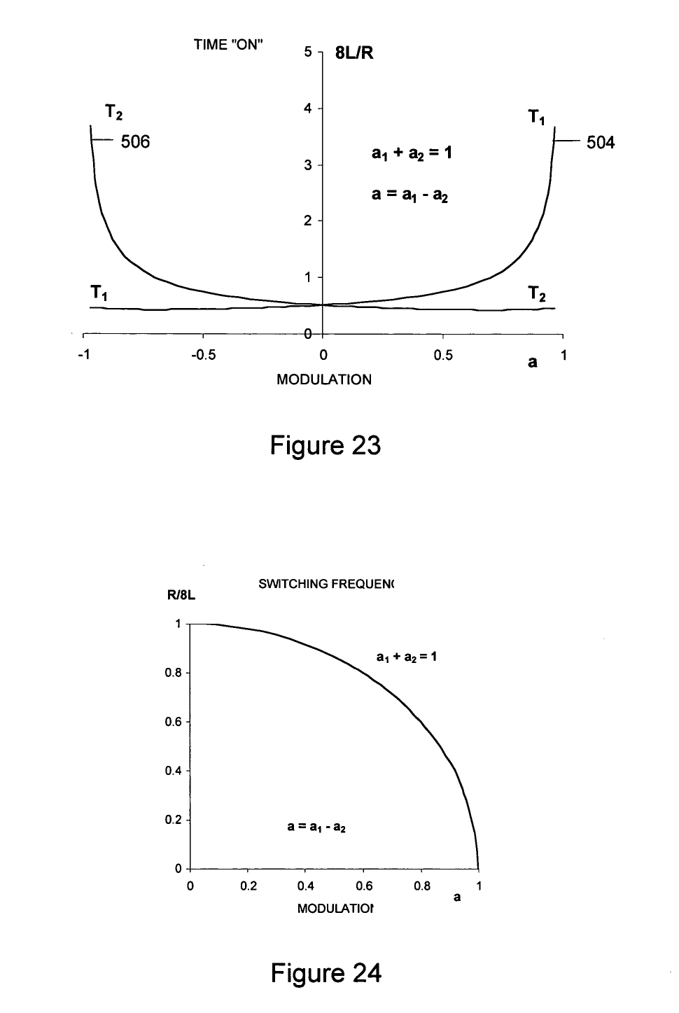

FIG. 23 illustrates in a graph the switching times, for power transistor 210a″ and 210b″ of amplifier 200″ of FIG. 22 as a function of modulation coefficient a. The vertical axis shows time ON and is expressed as a multiple of 8L/R, where L is inductance of the transformer 216″ and R is the total resistance of the coil 218″. Curve 504 represents the time ON for transistor 210a″, while curve 506 illustrates the time ON for power transistor 210b″. This figure is analogous FIG. 9 for amplifier 200.

FIG. 24 illustrates in a graph illustrates the switching frequency of amplifier 200″ as a function of modulation coefficient a.

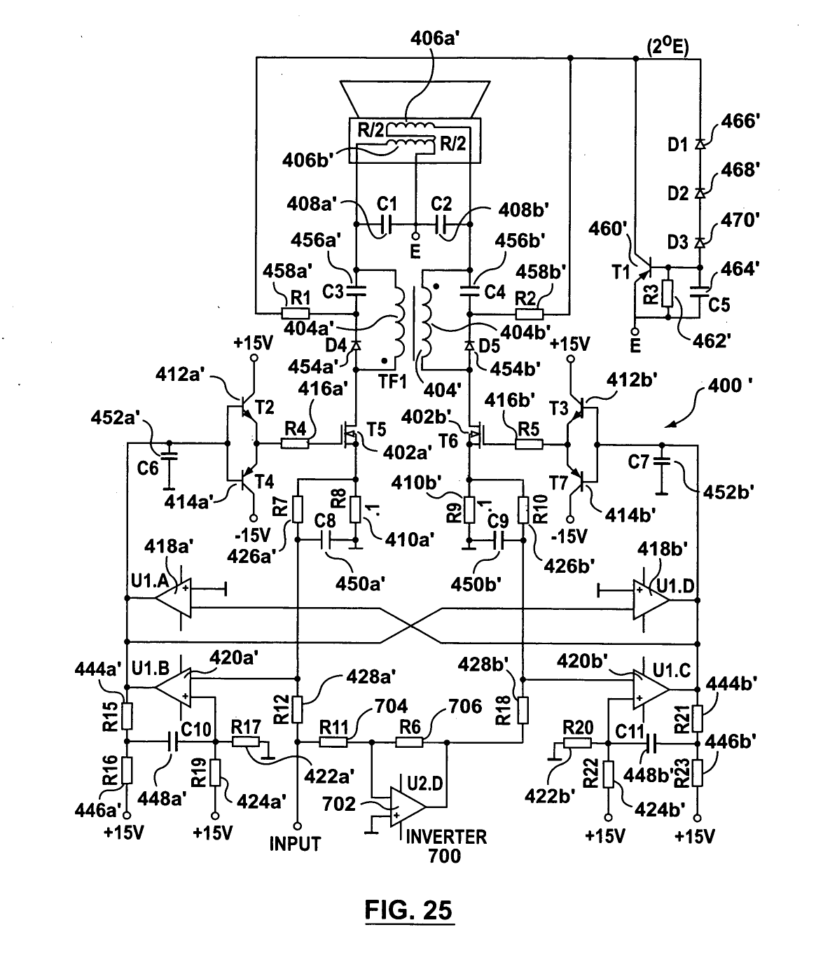

Referring to FIG. 25, there is illustrated in a detailed schematic diagram an amplifier 400′ in accordance with a further preferred embodiment of the invention. For clarity, the same reference numerals together with an apostrophe are used to designate elements analogous to those described above in connection with FIG. 19. For brevity, some of the description of FIG. 19 is not repeated with respect to FIG. 25. Transistors 402a′ and 402b′ are power-switching transistors, which are connected to transformer 404′. That is, the drain of each transistor 402a′, 402b′ is connected to a different winding of transformers 404′. In addition, the terminals of transformer 404′ to which the drains or transistors 402a′, 402b′ are attached, are of opposite polarity. The other terminals of transformer 404′ are connected to the speaker coils, 406a′ and 406b′, as well as to filtering capacitors 408a′ and 408b′.

Resistors 410a′ and 410b′ are current sensing resistors connected in series with the source terminals of transistors 402a′ and 402b′. These resistors provide a voltage at the source terminal that is proportional to the current passing through the sources of the transistors 402a′ and 402b′. Small signal transistors 412a′ and 414a′, in typical totem pole configuration, drive the gate of power transistors 402a′ through resistor 416a′. Similarly, small signal transistors 412b′ and 414b′ drive the gate of power transistor 402b′ through resistor 416b′. Power transistor 402a′ and 402b′ are turned OFF and ON in an alternating fashion when the current through the source of the conducting transistor reaches a threshold value. Thus, there are essentially two states of the circuit, one in which transistor 402a′ is conducting and the other in which transistor 402b′ is conducting. As there are periods of time between the switching of transistors in which it is necessary to maintain the current conditions, as well as the signals that affect the current state, a memory storage unit is required to store the current state of the circuit. An R-S flip-flop provides a memory unit for storing the current state of the circuit. The R-S flip-flop comprises voltage comparators 418a′, 420a′, 418b′ and 420b′, which in practice may be all on the same integrated circuit chip.

Each of the comparators 420a′ and 420b′ compare a weighted sum of the current through the source of one of the power transistors 402a′ and 402b′ and the input voltage with a reference voltage. The reference voltages are adjusted by two pairs of voltage dividing resistors 422a′ and 424a′, and resistors 422b′ and 424b′. Preferably, the resistance of resistor 422a′ equals the resistance of resistor 422b, and the resistance of resistor 424a′ equals the resistance of resistor 424b′, thereby causing the two reference voltages to be equal provided the resistors 424a′ and 424b′ are connected to the same voltage potential.

The resistors 426a′, 428a′ and 430a′, and resistors 426b′, 428b′ and 430b′, along with resistors 410a′ and 410b′, are scaling resistors. The relative values of the resistances of these resistors establishes the relationship between the input signal, the threshold currents and the reference voltage. The appropriate resistances for each of the resistors can be determined from simple principles of voltage division. In practice, it is preferable to have the resistance of resistor 410a′ equal to the resistance of resistor 410b′, the resistance of resistor 426a′ equal to the resistance of resistor 426b′, and the resistance of resistor 430a′ equal to the resistance of resistor 430b′, and the resistance of resistor 428a′ equal to the resistance of resistor 428b′, thereby assuring that each comparator uses the same weighted sum of the input voltage, source current and reference voltage.

As described above, the structure of much of the amplifier circuit 400′ is symmetrical. That is, one of the halves processes the negative portion of the input signal and the other processes the positive portion. Inverter 700, comprising of operational amplifier 702 and resistors 704 and 706, inverts the input signal for the second branch of the circuit.

Resistors 444a′, 446a′, 444b′ and 446b′ are pull up resistors that are necessary for the proper operation of the voltage comparators 418a′ and 418b′. Capacitors 448a′ and 448b′ provide a feedback loop for the current sensing comparators between the output and non-inverting input. This allows for faster switching times and short dead time zones, which is necessary for the proper functioning of the R-S flip-flop. Capacitors 450a′, 450b′, 452a′ and 452b′ are used to reduce high frequency noise and to improve circuit stability.

Transformer 404′ provides for energy storage and transfer. When one of the power transistors 402a′ or 402b′ is ON, energy is accumulated within the inductance of the transformer 404′ as a result of current flowing through one of the windings of the transformer 404′. When the power transistor is turned OFF, and the other transistor is switched on, the energy accumulated in the inductance is released into the second winding as an electrical current.

It is important to achieve effective coupling between both transformer windings 404a′ and 404b′ in order to maximize efficiency and limit parasitic inductances that can lower the efficiency of energy transfer and cause voltage spikes in the drain of the switched OFF power transistor. If the voltage spike reaches the transistor breakdown voltage, then this additional energy is discharged through the transistor, dissipating additional heat. This heat energy dissipated should not be higher than the rated avalanche energy of the transistor. However, in high power applications, it is often difficult to limit this energy to below the avalanche energy of the transistor. To compensate for this, the amplifier 400′ includes a protective clamping circuit comprising clamping to diodes 454a′ and 454b′, capacitors 456a′ and 456b′, resistors 458a′ and 458b′, discharge circuit, including transistor 460′, resistor 462′, capacitor 464′ and zener diodes 466′, 468′ and 470′. The clamping voltage should be less than the transistor breakdown voltage, and is selected by the zener diodes 466′, 468′ and 470′.

Various alternatives to the preferred embodiments of the amplifier are possible. For example, the amplifier could be implemented using a variety of technologies including, but not limited to, printed circuit board and integrated circuit implementations. In addition, the power switching transistors 72 and 74 of FIG. 19 are indicated as being MOSFET transistors yet the design may be implemented using bipolar transistors as well. This variation may require other modifications as well, such as diodes connected between the emitters and collectors of these transistors; however, the scope of the invention would not be departed from. Furthermore, a number of aspects of the designs shown in FIGS. 19 and 25 are, although useful, not integral to the invention. For example, the clamping networks and filtering capacitors may be omitted. If the filtering capacitors are omitted, then the high frequency currents i₁ and i₂ will be supplied to the coils rather than merely the average currents iₐ₁ and iₐ₂. However, while this is not preferred, the speaker will still operate as the high frequency signals are at a sufficiently high frequency that a listener will only be able to hear the average audio output resulting from these high frequency signals. Additionally, although there are many advantages to controlling the power transistors based on the current sensing techniques described above, this is not necessary and alternative controlling techniques may be used. All such modifications or variations are believed to be within the sphere and scope of the invention as defined by the claims appended hereto.

1. A switching power amplifier for connection to a split voice coil of a speaker, the split voice coil having a first coil and a second coil located in a magnetic field, the first coil and the second coil being wired such that current can be provided to one coil without providing current to the other coil, the power amplifier comprising:
a) a first branch for providing a first audio current to the first coil;
b) a second branch for providing a second audio current to the second coil, wherein the first audio current differs from the second audio current, and
c) a transformer for transferring energy between the first branch and the second branch such that both the first audio current and the second audio current constructively contribute to a force provided to the voice coil.

2. The switching power amplifier as defined in claim 1 wherein:
the first branch comprises a first switching element for controlling a first current in the first branch;
the second branch comprises a second switching element for controlling a second current in the second branch, wherein
the first current and the second current have a selected high frequency period,
the first audio current is the average of the first current over the high frequency period, and
the second audio current is the average of the second current over the high frequency period.

3. The switching power amplifier as defined in claim 2 wherein the transformer comprises a first winding in the first branch and a second winding in the second branch, the first winding having a first terminal for receiving current flowing from the first branch and the second winding having a second terminal for receiving current flowing from the second branch, the first winding in the first branch and the second winding in the second branch being oriented such that the first terminal and the second terminal are of opposite polarity.

4. The switching power amplifier as defined in claim 2 wherein the transformer is one of a high frequency transformer and an impulse transformer.

5. The switching power amplifier as defined in claim 2 further comprising
a first filtering capacitor for filtering high frequency components from the first current, the first filtering capacitor being connected to the first branch; and,
a second filtering capacitor for filtering high frequency fluctuations from the second current, the second filtering capacitor being connected to the second branch.

6. The switching power amplifier as defined in claim 2 wherein
the first audio current is provided concurrently with the second audio current, and
the first current and the second current are alternately supplied to the first branch and the second branch respectively such that the second current is interrupted when the first current is supplied to the first branch, and the first current is interrupted when the second current is supplied to the second branch.

7. The switching power amplifier as defined in claim 6 further comprising switching means for controlling
(i) the first switching element to terminate the first current at a variable first threshold magnitude at the end of a first time interval in each high frequency period,
(ii) the second switching element to terminate the second current at a variable second current termination magnitude at the end of a second time interval in each high frequency period; wherein
the transformer is a substantially 1:1 transformer, the first winding having a first terminal connected to the first switching element and the second winding having a second terminal connected to the second switching element, the second terminal being opposite in polarity to the first terminal such that the transformer is operable to transfer energy
from the first branch to the second branch during of the first interval to commence the second current at the associated first threshold magnitude, and
from the second branch to the first branch during the second interval to commence the first current at the associated second threshold magnitude.

8. The switching power amplifier as defined in claim 6 wherein the switching means is operable to control the variable first threshold magnitude and the variable second threshold magnitude from high frequency period to high frequency period to control the first audio current and the second audio current.

9. The switching power amplifier as defined in claim 2 further comprising
a power supply connection means for providing power to the first coil and the second coil; and,
a signal input branch for receiving an input signal providing audio information to the speaker; and
at least one signal circuit for dividing the input signal to provide the first signal and the second signal.

10. A method of providing an audio current comprising a first audio current and a second audio current to a split voice coil speaker having a first coil and a second coil located in a magnetic field, the first coil and the second coil being wired such that current can be provided to one coil without providing current to the other coil, the method comprising:
a) providing the first audio current to a first branch connected to the first coil;
b) providing the second audio current to a second branch connected to the second coil, wherein the first audio current differs from the second audio current;
c) orienting the first audio current in the first coil and the second audio current in the second coil such that both the first audio current and the second audio current constructively contribute to a force provided to the voice coil.

11. The method as defined in claim 10 wherein
step (a) comprises providing a first current to the first branch;
step (b) comprises providing a second current to the second branch;
the first current and the second current have a selected high frequency period,
the first audio current is the average of the first current over the high frequency period, and
the second audio current is the average of the second current over the high frequency period.

12. The method as defined in claim 11 further comprising transferring energy between the first branch and the second branch to make both the first current and the second current bi-directional.

13. The method as defined in claim 12 wherein the step of transferring energy between the first branch and the second branch is performed by a transformer having a first winding in the first branch and a second winding in the second branch.

14. The method as defined in claim 13 wherein the transformer is one of a high frequency transformer and an impulse transformer.

15. The method as defined in claim 12 further comprising
filtering high frequency components from the first current to provide the first audio current; and,
filtering high frequency components from the second current to provide the second audio current.

16. The method as defined in claim 12 wherein
the first audio current is provided concurrently with the second audio current, and
the first current and the second current are alternately supplied to the first branch and the second branch respectively such that the second current is interrupted when the first current is supplied to the first branch, and the first current is interrupted when the second current is supplied to the second branch.

17. The method as defined in claim 16 wherein
the first branch comprises a first switching element for controlling a first current; and,
the second branch comprises a second switching element for controlling a second current.

18. The method as defined in claim 17 further comprising
controlling the first switching element to terminate the first current at a variable first threshold magnitude at the end of a first time interval in each high frequency period;
controlling the second switching element to terminate the second current at a variable second current termination magnitude at the end of a second time interval in each high frequency period;
transferring energy from the first branch to the second branch during the first interval to commence the second current at the associated first threshold magnitude; and,
transferring energy from the second branch to the first branch during the second interval to commence the first current at the associated second threshold magnitude.

19. The method as defined in claim 18 further comprising controlling the variable first threshold magnitude and the variable second threshold magnitude from high frequency period to high frequency period to control the first audio current and the second audio current.

20. The method as defined in claim 11 further comprising dividing an input signal to provide the first signal and the second signal.

21. The method as defined in claim 11 wherein the first current and the second current are selected to be substantially inaudible when provided to the first coil and the second coil to impede sound distortion.

22. A speaker comprising:
a split voice coil having a first coil and a second coil located in a magnetic field, the first coil and the second coil being wired such that current can be provided to one coil without providing current to the other coil, and,
a power amplifier comprising
(a) a first branch for providing a first audio current to the first coil;
(b) a second branch for providing a second audio current to the second coil, wherein the first audio current differs from the second audio current, and
(c) a transformer for transferring energy between the first branch and the second branch such that both the first audio current and the second audio current constructively contribute to a force provided to the voice coil.

23. The speaker as defined in claim 22 wherein:
the first branch comprises a first switching element for controlling a first current in the first branch;
the second branch comprises a second switching element for controlling a second current in the second branch, wherein
the first current and the second current have a selected high frequency period,
the first audio current is the average of the first current over the high frequency period, and
the second audio current is the average of the second current over the high frequency period.

24. The speaker as defined in claim 23 wherein
the transformer comprises a first winding in the first branch and a second winding in the second branch, the first winding having a first terminal for receiving current flowing from the first branch and the second winding having a second terminal for receiving current flowing from the second branch, the first winding in the first branch and the second winding in the second branch being oriented such that the first terminal and the second terminal are of opposite polarity.

25. The speaker as defined in claim 23 wherein the transformer is one of a high frequency transformer and an impulse transformer.

26. The speaker as defined in claim 23 wherein the power amplifier further comprises
a first filtering capacitor for filtering high frequency components from the first current, the first filtering capacitor being connected to the first branch; and,
a second filtering capacitor for filtering high frequency components from the second current, the second filtering capacitor being connected to the second branch.

27. The speaker as defined in claim 23 wherein
the first audio current is provided concurrently with the second audio current, and
the first current and the second current are alternately supplied to the first branch and the second branch respectively such that the second current is interrupted when the first current is supplied to the first branch, and the first current is interrupted when the second current is supplied to the second branch.

28. The speaker as defined in claim 27 wherein the power amplifier further comprises switching means for controlling
(i) the first switching element to terminate the first current at a variable first threshold magnitude at the end of a first time interval in each high frequency period,
(ii) the second switching element to terminate the second current at a variable second current termination magnitude at the end of a second time interval in each high frequency period; wherein
the transformer is a substantially 1:1 transformer, the first winding having a first terminal connected to the first switching element and the second winding having a second terminal connected to the second switching element, the second terminal being opposite in polarity to the first terminal such that the transformer is operable to transfer energy
from the first branch to the second branch during of the first interval to commence the second current at the associated first threshold magnitude, and
from the second branch to the first branch during the second interval to commence the first current at the associated second threshold magnitude.

29. The speaker as defined in claim 27 wherein the switching means is operable to control the variable first threshold magnitude and the variable second threshold magnitude from high frequency period to high frequency period to control the first audio current and the second audio current.

30. The speaker as defined in claim 22 further comprising
a power supply connection means for providing power to the first coil and the second coil; and,
a signal input branch for receiving an input signal for providing audio information to the speaker; and
at least one signal circuit for dividing the input signal to provide the first signal and the second signal.
